(19) United States
(12) Patent Application Publication
(10) Pub. No.: US 2002/0128000 A1
(43) Pub. Date: Sep. 12, 2002

(54) Driving detection/notification and location/situation-based services

(76) Inventor: Oswaldo L. do Nascimento, JR., Wellesley, MA (US)

Correspondence Address: MINTZ, LEVIN, COHN, FERRIS,, GLOVSKY and POPEO, P.C., One Financial Center, Boston, MA, 02111, US

(21) Appl. No.: 10/067,468

(22) Filed: Feb. 4, 2002

Related U.S. Application Data
(60) Provisional application No. 60/266,773, filed on Feb. 6, 2001.
(60) Provisional application No. 60/275,424, filed on Mar. 13, 2001.

(51) Int. Cl. H04M 3/42

(52) U.S. Cl. 455/414

(57) ABSTRACT

A system for use with a mobile communication unit includes a service device configured to determine at least one service to be applied to affect at least one of incoming and outgoing communications to and from, respectively, the mobile communication unit, the service device being configured to determine the at least one service to be applied dependent upon a location of the mobile communication unit, and a controller coupled to the service device and configured to implement the at least one service to affect the at least one of incoming and outgoing communications to and from the mobile communication unit, respectively. The location can be in a set of locations in which the mobile communication unit can send or receive communications to or from, respectively, at least one of a network associated with the mobile communication unit and another communication device associated with the mobile communication unit. The service to be applied is independent of a cost for communications using the mobile communication unit at the location.

### CROSS-REFERENCE TO RELATED ACTIONS

This application claims the benefit of U.S. Provisional Application Serial No. 60/266,773 filed Feb. 6, 2001 and entitled “Driving Detection/Notification and Location-Based Services” and the benefit of U.S. Provisional Application Serial No. 60/275,424 filed Mar. 13, 2001 and entitled “Driving Detection/Notification and Location/Situation-Based Services.”

### BACKGROUND OF THE INVENTION

The invention relates to communication systems and in particular to mobile communication systems such as mobile telephones, personal data assistants, pagers and computers.

Mobile telephones have become widespread and commonplace in today's society. Many people around the world use these telephones to communicate with others. Some mobile telephone users use these phones in place of traditional hard-wired phones in their homes. Many people use mobile phones to communicate with others when a traditional hard-wired phone is not convenient, such as when such a phone is not nearby or when the user is in transit. Mobile communication systems allow persons to contact the owner/user of the system when the location of the user is not known and/or the availability and/or contact information for non-mobile systems, e.g., a public pay telephone number, is not known by the person attempting to make contact.

Many mobile telephone users take advantage of the ability to use mobile phones while in transit to make phone calls while traveling in cars or other vehicles. Frequently, the mobile phone user is the driver of the car. If the user is driving, safety can be compromised as the user's attention is drawn away from the task of driving and to the phone, such as for dialing phone numbers. This is especially true in the common case where the user cannot operate the phone in a hands-free fashion (i.e., without having to touch the phone to dial or to instruct the phone to perform other functions). Indeed, driving accidents in some areas due to mobile phone use exceed those due to driving under the influence, e.g., of alcohol. To discourage mobile phone use while the user is driving to help improve safety, some countries, such as Brazil, Chile, Italy, Israel, Japan, and others, have adopted laws forbidding mobile phone use while driving.

Additionally, the mobile communication system (MWS) is becoming a dominant communication and information delivery system as users rely more and more on the MWS for a majority of communication (560 million users worldwide, going to 2 billion)-voice communication or computer communication. Users rely on the MWS ability to allow other persons to contact them on their system. Consequently, they leave their mobile system on, allowing it to accept all incoming communications. Frequently, the mobile system user enters a situation in which an incoming communication can cause a disruption, for example, a mobile telephone ringing or an e-mail notification buzz during a theatrical performance.

Some incoming communications may be desirable always, such as an emergency messages from a child or caregiver, while others may only be desirable in a particular situation or location, such as a spouse giving a grocery list while you are in the grocery store.

To eliminate disruptions due to undesirable incoming communications to mobile wireless systems, many situations and locations, such as theatrical performances, cinema showings, and business meetings, require that all mobile communication/computer devices be turned off. Turning off a mobile system prevents all incoming communications, even emergency and other desirable communications from reaching the mobile system user, thereby decreasing the usefulness and desirability of the system.

### SUMMARY OF THE INVENTION

In general, in an aspect, the invention provides a system for use with a mobile communication unit. The system includes a service device configured to determine at least one service to be applied to affect at least one of incoming and outgoing communications to and from, respectively, the mobile communication unit, the service device being configured to determine the at least one service to be applied dependent upon a location of the mobile communication unit, and a controller coupled to the service device and configured to implement the at least one service to affect the at least one of incoming and outgoing communications to and from the mobile communication unit, respectively. The location can be in a set of locations in which the mobile communication unit can send or receive communications to or from, respectively, at least one of a network associated with the mobile communication unit and another communication device associated with the mobile communication unit. The service to be applied is independent of a cost for communications using the mobile communication unit at the location.

Implementations of the invention may include one or more of the following features. The service includes routing the incoming communication to a destination other than the mobile communication unit. The destination other than the mobile communication unit is one of a voicemail system and a further communication device. The service comprises at least one of blocking the incoming communication, playing a message, screening the incoming communication, storing the incoming communication, automatically calling back a device originating the incoming communication in response to the mobile communication unit leaving the location, and notifying a user of the mobile communication unit that a service is still active after the mobile communication unit leaves the location. The service device is configured to determine the location by using information from the network associated with the mobile communication unit. The service device is configured to determine the location by using information independent of information from the network associated with the mobile communication unit. The service device is configured to determine the location by using information from a global positioning satellite system. The service device is configured to determine the location by using information from a transmitter disposed at the location. The location is a region. The region is one in which incoming communications to a mobile communication unit are disallowed. The service device is further configured to determine the at least one service to be applied dependent upon a situation of the mobile communication unit. The situation of the mobile communication unit includes at least one of time of day and speed of the mobile communication unit.

In general, in another aspect, the invention provides a method of providing services relating to at least one of incoming and outgoing communications to and from, respectively, a mobile communication unit. The method includes determining a location of the mobile communication unit, the location being within a set of locations in which the mobile communication can communicate with at least one of a network associated with the mobile communication unit and another communication device associated with the mobile communication unit, selecting a service depending upon the location of the mobile communication unit, the service affecting at least one of incoming and outgoing communications to and from, respectively, the mobile communication unit, and affecting at least one of an incoming communication to, and an outgoing communication from, the mobile communication unit in accordance with the selected service. The service to be applied is independent of a cost for communications using the mobile communication unit at the location.

Implementations of the invention may include one or more of the following features. The affecting includes routing the incoming communication to a destination other than the mobile communication unit. The destination other than the mobile communication unit is one of a voicemail system and a further communication device. The affecting includes at least one of blocking the incoming communication, playing a message, screening the incoming communication, storing the incoming communication, automatically calling back a device originating the incoming communication in response to the mobile communication unit leaving the location, and notifying a user of the mobile communication unit that a service is still active after the mobile communication unit leaves the location. The selecting includes at least one of using information from the network associated with the mobile communication unit, using information independent of information from the network associated with the mobile communication unit, using information from a global positioning satellite system, and using information from a transmitter disposed at the location. The method further includes determining a situation of the mobile communication unit, and wherein the selecting a service further depends on the situation of the mobile communication unit. The situation of the mobile communication unit includes at least one of time of day at the mobile communication unit and speed of the mobile communication unit.

In general, in another aspect, the invention provides a portable communication device configured to at least receive communications, the device including a receiver configured to receive a location communication indicative of location of the portable communication device, a transmitter configured to transmit information indicative of the location of the portable communication device in accordance with the location communication, and a controller configured to inhibit incoming communications, other than the location communication, to the portable communication device in response to the location communication being associated with a location in which incoming communications other than the location communication to the portable communication device are prohibited.

Implementations of the invention may include one or more of the following features. The controller is further configured to allow incoming communications, in addition to the location communication, to be received and processed by the portable communication device in response to a location communication indicating that the portable communication device is in a location that permits incoming communications other than the location communication.

In general, in another aspect, the invention provides a system for use with a mobile communication unit, the system including service means for determining at least one service to be applied to affect at least one of incoming and outgoing communications to and from, respectively, the mobile communication unit, the service means for determining the at least one service to be applied dependent upon a location of the mobile communication unit and a situation of the mobile communication unit, and control means, coupled to the service means, for implementing the at least one service to affect the at least one of incoming and outgoing communications to and from the mobile communication unit, respectively, where the location can be in a set of locations in which the mobile communication unit can send or receive communications to or from, respectively, at least one of a network associated with the mobile communication unit and another communication device associated with the mobile communication unit, and where the service to be applied is independent of a cost for communications using the mobile communication unit at the location.

Also, embodiments of the invention provide techniques for determining that a mobile system, such as a mobile telephone, is likely to be in a situation and/or at a location requiring a particular type of service and incoming communication screening. Every situation (according to, e.g., speed, motion, timing) and/or location has a particular ‘type’ associated with it. A situation/location type determines the possible screening and services provided to a mobile system when it is in that situation and/or at that location. The mobile station communication is affected by one or more possible value-added services depending on the user's situation and/or location and the situation and/or location type. Services that can be provided include transferring a party, connecting a mobile system caller to a message service of the mobile system user, disconnecting the communication, informing each party to the call of action to be taken, giving each party instructions as to how to proceed, and/or storing contact information. These services can thus provide, e.g., notifications, routing and rerouting of communications, messaging (including two-way messaging), announcements. setup, initialization, activation, running or temporarily disabling computer applications and programs.

Various embodiments of the invention may provide one or more of the following advantages. Road safety can be improved. The frequency and/or number of violations of laws prohibiting mobile phone use while driving can be reduced compared to the current frequency and/or number. Mobile phone users can be notified of potential safety and legal concerns associated with driving while using a mobile phone. Useful and safe options to enabling or continuing calls to or from a current or prospective mobile phone user that is driving can be implemented. Communication between persons can be assisted without enabling or continuing calls to or from a current or prospective mobile phone user that is driving. Communications such as calls can be routed or rerouted as desired, such as to promote safety and/or prevent illegal activity. Mobile phone users can receive messages, be informed of emergencies, and be allowed to send prerecorded messages, even if the user is driving. Drivers can use mobile phones during emergencies. Security concerns of mobile communications users can be improved. Driving safety can be improved and illegal activity reduced. Additional revenue can be realized due to additional services provided to mobile phone users. Vehicular accidents and corresponding healthcare and insurance costs can be reduced. Mobile phone users can be alerted to traffic laws and possible violations thereof. Traffic management and control (e.g., vehicle routing depending on traffic conditions) can be improved. Vehicles and other assets can be tracked and managed. Resource allocation in telephone operator networks can be improved or optimized, e.g., for handoff and other mobile-related communication processing depending on, for example, the number of mobile communication system users in an area. Communication services can be provided such as blocking communications, enabling communications, prompting for responses as to whether a user is a driver or the communication is an emergency, disconnecting communication connections, playing messages, and routing communications, e.g., to voicemail boxes. Safety of motor vehicle travel can be improved. Telecommunication channel progress can be accommodated and channel access can be managed, controlled, and organized. Messages delivered to a mobile communication unit user can be managed by the user. Interference between devices or allocation of devices to a piconet can be reduced or eliminated.

Various embodiments of the invention may also provide one or more of the following advantages. The number of undesirable disruptions due to incoming communications can be reduced compared to the current frequency and/or number when the system is active. Road safety can be improved as technology and screening software for safety and service are applied for highway and road usage. The frequency and/or number of accidents or violations of laws prohibiting mobile system use while driving can be reduced. Mobile system users can improve their access to potential safety services and their compliance with and/or attention to legal concerns associated with using a mobile system in a particular location/situation. Useful and safe options to enabling or continuing calls to or from a current or prospective mobile system user can be implemented. Communication between persons can be assisted without enabling or continuing calls to or from a current or prospective mobile system user that is within a particular type of situation/location. Communications such as calls can be routed or rerouted as desired, such as to conform to social norms and/or promote safety and/or prevent illegal activity. Mobile system users can receive messages, be informed of emergencies, and be allowed to send prerecorded messages, even if the user is in a typed situation/location. Users can use mobile systems for outgoing communications and can be reached during emergencies. Users can be reached by desirable parties if the users are in appropriate situations/locations. Security concerns of mobile communications users can be improved. Additional revenue can be realized due to additional services provided to mobile system users. Vehicular accidents and corresponding healthcare and insurance costs can be reduced.

### BRIEF DESCRIPTION OF THE DRAWINGS

FIG. 1 is a simplified partially-block diagram schematically showing interconnections of components of a system according to the invention.

FIG. 2 is a schematic diagram of a process of connecting a mobile-station-initiated call from a mobile station user that confirms that the user is not driving.

FIG. 3 is a schematic diagram of processing of a mobile-station-initiated call from a mobile station user that fails to confirm whether the user is driving.

FIG. 4 is a schematic diagram of processing of a mobile-station-initiated call from a mobile station user that confirms that the user is driving.

FIG. 5 is a schematic diagram of a process of connecting a mobile-station-terminated call to a mobile station user that confirms that the user is not driving.

FIG. 6 is a schematic diagram of processing of a mobile-station-terminated call to a mobile station user that fails to confirm whether the user is driving.

FIG. 7 is a schematic diagram of processing of a mobile-station-terminated call to a mobile station user that confirms that the user is driving.

FIG. 8 is a schematic diagram of a process of reconnecting a call in progress with a mobile station user that confirms that the user is not driving.

FIG. 9 is a schematic diagram of processing of a mobile-station call in progress where a mobile station user fails to confirm whether the user is driving.

FIG. 10 is a schematic diagram of processing of a mobile-station call in progress where a mobile station user confirms that the user is driving.

FIG. 11 is a schematic diagram of processing of a mobile-station-terminated call to a mobile station user that confirms that the user is driving where a party calling the mobile station user indicates that the call is an emergency.

FIG. 12 is a schematic diagram of a system for identifying the location of a mobile station and contacting the closest entity or entities to the mobile station.

FIG. 13 is a simplified partially-block diagram schematically showing interconnections of components of another system according to the invention.

FIG. 14 is a block diagram of a mobile station and a remote mobile module shown in FIG. 13.

FIG. 15 is a block diagram of a wireless vehicle communication system shown in FIG. 13.

FIG. 16 is a block diagram of a process of operation of the system shown in FIG. 13.

FIG. 17 is a simplified diagram of a system for providing location/situation-based telecommunication services.

### DETAILED DESCRIPTION OF PREFERRED EMBODIMENTS

Embodiments of the invention provide techniques for determining that a mobile station, such as a mobile phone, is likely to be traveling in a car or other vehicle when a call is in progress or attempting to be made, and acting accordingly. For example, the invention provides a system that uses the estimated value of the speed of a Mobile Station (MS) to inquire if a user of the MS is a driver or not. The speed of the MS may suggest that the MS is being used by a person that is driving, e.g., if the MS is moving excessively fast (e.g., above threshold level). If the speed of the MS suggests that its user may be driving, then the system sends a message to the MS requesting information as to whether the MS is used by a driver or not. If a “not driving” message is sent by the MS, indicating that the user is not driving, then the system stores this information in a database. If a “not driving” message is not sent, the system can proceed accordingly such as by either disconnecting the call or giving instructions for both parties to a call about how to proceed, and storing call information. The system can notify the user of possible undesired/unlawful activity, route and/or reroute calls, provide messaging (including two-way messaging) to the user and another party to a current or prospective communication with the user, and provide announcements. Emergency calls can be enabled even if the MS user is driving. For emergency calls, call information is stored.

The following description refers to the MS as a mobile telephone (such as a third-generation mobile phone) or a cellular telephone. While such MS's have wide applicability, the MS can take other forms. The MS can be a wireless device capable of mobile communication, especially two-way communication. For example, the MS could be a palmtop, laptop, or handheld computer, a wideband data/voice integrated device such as an electronic organizer, a one-way or two-way pager, or a computer installed in a vehicle. These devices can provide abilities and/or services such as telephone communications, one-way or two-way paging, and email and Internet connection at mobile locations such as in a car. Such communication can be full duplex communication using, e.g., satellite links, or cellular and/or PCS infrastructure of the frequency spectrum. The communication can use a variety of media such as radio waves and antennas, optical fibers or other optical transmission media, and satellites. Other forms of mobile communication and transmission systems and/or media either known or developed in the future would be acceptable and within the scope of the invention. Also, the description refers principally to calls although other communications are possible.

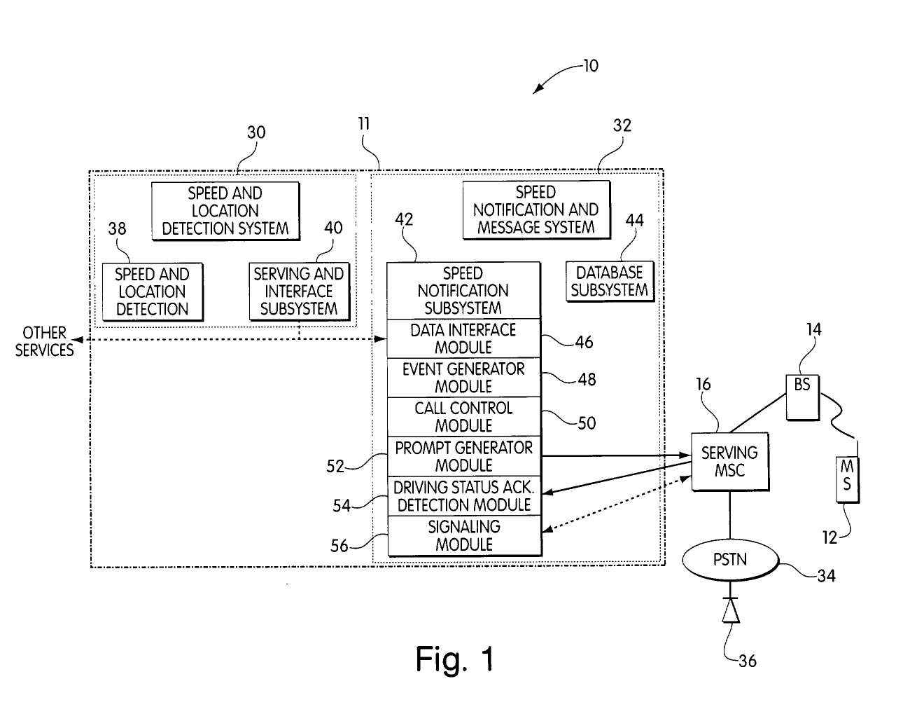

Referring to FIG. 1, a Speed Detection, Notification, and Messaging (SDNM) system 10 includes a Speed and Location Detection and Notification Module (SLDNM) 11, that includes a Speed and Location Detection System (SLDS) 30 and a Speed Notification and Message System (SNMS) 32, a Mobile Station (MS) 12, a base station 14, a serving Mobile Switching Center (MSC) 16, a Public Switched Telephone Network (PSTN) 34, and a phone 36. As shown, the MS 12 is connected by a wireless link to the base station 14. The base station 14 is hard-wire connected to the serving MSC 16. The serving MSC 16 is connected to the SNMS 32 and the PSTN 34. All of these connections are bidirectional, with the serving MSC 16 being connected to the SNMS 32 by multiple, one-way connections and a two-way connection, as shown. Communication links shown in FIG. 1 in dashed lines are for signaling communications and those shown in solid, bold lines represent voice and Dual-Tone Multi-Frequency (DTMF) communications.

The SLDNM 11 includes a voice machine, SS7 servers, central control machines, and an Operation and Maintenance (O&M) machine.

The voice machine supplies resources to interface with users of the MS 12, play prompts, and receive feedback via Dual-Tone Multi-Frequency (DTMF) tones and speech recognition. The voice machine uses Intel®-based and Compact PCI (cPCI) bus platform with a cPCI 19U high enclosure with 8 6U sized slots, an H110 CT bus backplane, hot swappable fans, and front bays for a floppy drive and a CD-ROM drive. For example, an Advantech MIC3032/8 or MIC3021-8, made by Advantech, Inc. of Annapolis, Md., may be used. A CPU board with a Pentium® III 70 Mhz processor (made by Intel® Corp. of Santa Clara, Calif.) and 256 Mbytes of RAM such as Advantech's MIC3365 or MIC3376 may be used. A voice board such as a Natural MicroSystems AG4000C/1600-2T1 (made by Natural MicroSystems Corp. of Framingham, Mass.) with Natural Access software drivers, and Nuance 7.0 speech recognition software (made by Nuance Communications of Menlo Park, Calif.) may be used. The voice machine may use a Linux operating system.

The SS7 servers provide connectivity for the SLDNM 11. Two SS7 servers are used, each connected to a Signal Transfer Point (STP), and each connected to the other SS7 server. The SS7 servers also use a cPCI bus and Intel®-based platform. Each SS7 enclosure features a cPCI bust platform that is 19U high, 8 6U sized slots, an H110 CT bus backplane, hot swappable fans, front bays for a floppy drive and a CD-ROM drive, a −48V redundant power supply, and an alarm panel. For example, Advantech's MIC3032/8 or MIC-2031-8 may be used. CPU boards with a Pentium® III 700 MHz processor and 256 Mbytes of RAM, such as Advantech's MIC3365 or MIC3376, may be used. For an interface, the SS7 machine may use a DataKinetics CPM8 with a rear teransition board such as CPR8RJ. The interface board has T1/E1/V35 interfaces. The SS7 protocols used are SS7 MTP, SS7 ISUP, SS7 SCCP, SS7 TCAP, and SS7 INAP, and the operating system is Linux.

The central control machines supply location signaling, communication control, and database management. A cluster of machines are provided to help ensure high availability, scalability, and affordability. The central control includes a database server, a location server and a call/communication control server. The database server stores information, e.g., to help identify users, of locations and speeds of users, and of chosen user options. The location server receives information regarding MS location. The call/communication control server controls the voice and SS7 machines and implements services based on, e.g., responses from users. The central control can be implemented using a Sun Microsystems® Enterprise 220R server (made by Sun Microsystems® Inc. of Palo Alto, Calif.), with 2 450 MHz processors, 2 Gbytes of RAM, and a redundant power supply.

The O&M machine provides resources for system operations and maintenance. The O&M machine uses CORBA to interface with the SS7 machines, voice machine, and central control and database servers, and uses HTTP to interface with an operator terminal. The operator terminal can employ a web browser for sending and receiving information regarding system and user status. The O&M machine can be implemented with a Sun Microsystems® Enterprise 5 platform with a 450 MHz processor and 512 Mbytes of RAM using a Solaris® SPARC® operating system.

Portions of the system 10, and in particular of the SLDS 30 and the SNMS 32, are preferably implemented with software code that is stored on computer-readable media and that includes instructions that are readable by a computer for causing the computer to perform operations as described herein according to the instructions. The functions can, however, be implemented in the various portions of the system 10 using hardwiring, hardware, firmware, software, or combinations of any of these. Additionally, these functions can be performed by portions of the system 10 that would deviate from the physical depiction shown in FIG. 1 without departing from the scope and spirit of the invention. FIG. 1 is thus intended as illustrative and not limiting as to the physical location of the performance of functions described. Functions described as being performed by a particular block in FIG. 1 can be performed wholly or partially in other portions of the system 10 than as described.

The SLDS 30 includes a Speed Location and Detection Module (SLDM) 38 and a Serving and Interface Subsystem (SIS) 40. The SLDM 38 is adapted to acquire information about the MS 12, including speed and location, and information about the date and time of day. The SLDM 38 can acquire data regarding the average speed of the MS 12 to determine when the MS 12 is moving, according to its average speed, faster than a threshold. The data regarding the average speed can be, e.g., position and location information over time, speed over time, or average speed itself. If other than average speed itself, the SLDM 38 calculates the average speed. An average speed, over a predetermined time period, is used to guard against erroneous inferences that the user may be driving, for example if the MS 12 is dropped and briefly exceeds the threshold speed. A Global Positioning System (GPS) may be included in the SLDM 38 to ascertain the location and/or speed of the MS 12. Alternatively, information from, e.g., local cellular phone processing stations can relay information about a particular MS 12. In this case, the SLDM 38 includes appropriate memory that stores software code, and a processor for executing the stored code. By executing the code, the SLDM 38 can process the received signals to determine a speed and location of the MS 12. Alternatively still, the MS 12 could include a GPS system and the SLDM 38 could determine the average speed of the MS 12 from signals from the GPS in the MS 12. The information obtained by or calculated by the SLDM 38 is processed by the SIS 40. The SIS 40 includes an open-standard data communication interface that can provide information (e.g., information for performing functions described herein) to other portions of the system 10, including to service providers. These service providers can be the providers of the communication abilities of the MS 12 (e.g., a cellular phone service provider), or independent of such communication service providers. The independent service providers can work with the communication service providers. Services provided can include fleet management, traffic control, emergency services (e.g., vehicle and/or user location to direct emergency vehicles to the user's location), and police notification (e.g., for traffic violation identification, and/or user tracking such as if the user is wanted by the police).

The SNMS 32 includes a Speed Notification Subsystem (SNS) 42 and a Database Subsystem (DS) 44. The SNMS 32 is adapted to use the speed of the MS 12 and the call status of the MS 12 to provide services to a user of the MS 12. The DS 44 is adapted to store information regarding MS 12, e.g., location and speed, date and time of day, and responses to inquiries provided by the user of the MS 12.

The SNS 42 is connected to the SLDS 30 and is adapted to use information from the SLDS 30 to notify, advise, and affect calls or other communications with, the user of the MS 12. The SNS 42 can periodically receive information from the SLDS 30 regarding, e.g., the location, speed, and identity of an MS 12 within (or possibly approaching) a territory associated with the SLDS 30. The SNS 42 can also access information from, and store information in, the DS 44. Using the information from the SLDS 30 and the DS 44, the SNS 42 can determine whether the MS 12 is likely to be traveling in a car or other vehicle. This can be accomplished by, e.g., comparing the speed of the MS 12 with a predetermined rate. The rate need not be associated with a particular type of motor vehicle, and can be an upper threshold associated with non-motor-vehicle movement such as walking or riding in an elevator. The SNS 42 can also determine whether a call is in progress or attempting to be made using information received from the MSC 16 by the SLDNM 11 regarding calls or other communications. The SNS 42 can, in accordance with the speed determination and call status of the MS 12, send notices and messages to, and provide services to, the user and to the other party to the call. These notices can inform the user and/or the other party (actual or prospective) that the user is likely to be driving (e.g., moving above a threshold speed), identify the user's location (e.g., area of the city or highway), and inquire whether the user is driving. The user can be advised, e.g., about safety, legal, or other concerns regarding using the MS 12 while driving. The notices can also inform the other party to the call of any actions to be taken affecting the call and any services available to the party, such as leaving a message for the user.

The SNS 42 can receive the user's response to the inquiry, such as in the form of speech or a dual-tone multi-frequency (DTMF) signal produced by the user pressing a button on the MS 12. In accordance with the user's response to any inquiries and the call status and speed status of the MS 12, the SNS 42 can perform appropriate functions. Examples of these functions are connecting or reconnecting a call, stopping and/or disconnecting a call, forwarding a call, recording and/or delivering messages, and recording in the DS 44 information regarding the call and/or speed status of the MS 12. If the user responds that the user is not driving (a “not driving” response) or that the call is an emergency, then the SNS 42 can store this information in DS 44. If the user responds other than with a “not driving” or an “emergency call” response, or does not respond at all, then the SNS 42 can initiate appropriate action. Appropriate action can include transferring a party calling the mobile phone user to a message service of the mobile phone user, and/or disconnecting the call, and/or connecting/reconnecting the call, and/or informing each party to the call of action to be taken, and/or giving each party instructions as to how to proceed, and/or storing call information.

The SNS 42 includes a Data Interface Module (DIM) 46, an Event Generator Module (EGM) 48, a Call Control Module (CCM) 50, a Prompt Generator Module (PGM) 52, a Driving Status Acknowledgement Detection Module (DSADM) 54 and a Signaling Module (SM) 56.

The DIM 46 is connected to, and adapted to interface with, the SLDS 30 in accordance with a communication protocol. The DIM 46 is adapted to receive data to be used by the EGM 48 and convey these data to the EGM 48, and the DS 44 for storage. Also, the DIM 46 is adapted to remove data, from the DS 44, associated with an MS 12 that has not transmitted data for a predetermined amount of time.

The EGM 48 includes a state machine (not shown) associated with each MS 12 and under the control of the SLDS 30. A data input (not shown) is connected to the DIM 46 for receiving data from the DIM 46. The EGM can produce indications of at least three events: (1) the MS 12 is moving faster than the threshold and initiating a call; (2) the MS 12 is moving faster than the threshold and receiving a call; and (3) the MS 12 is currently in a call and begins moving faster than the threshold.

The CCM 50 is connected to the EGM 48 and adapted to receive indications from the EGM 48 of the three events. The CCM 50 is adapted to manage interactions between the MS 12 and another party, if any, to control a call to/from the MS 12. Interactions controlled by the CCM 50 include sending messages to the MS 12, receiving answers from the MS 12, and connecting calls to/from the MS 12. How the CCM 50 controls the interactions depends, e.g., on the call status and the answers provided by the MS 12. Also, in accordance with the answers provided by the MS 12, the CCM 50 updates the DS 44 with the identity and location of the MS 12, and the time.

The PGM 52 is adapted to interface with the MS 12 and the other party, if any, current or prospective, to a call to or from the MS 12. The PGM 52 is adapted to provide predetermined prompt messages to the MS 12 and the other party, under the control of the CCM 50.

DTMF and/or voice commands are detectable by the DSADM 54. The DSADM 54 is connected to the MSC 16 such that DTMF and/or voice commands from the MS 12 can be received, detected, and interpreted by the DSADM 54. In particular, the DSADM 54 can be adapted to interpret and/or recognize certain predefined speaker-independent voice commands. Indications of interpreted or otherwise detected commands can be sent by the DSADM 54 to the CCM 50, to which the DSADM 54 is connected.

The SM 56 is connected to the CCM 50 and the MSC 16 and is adapted to exchange data with the MSC 16 in order to implement call sequences according to instructions from the CCM 50. The SM 56 can request the MSC 16, e.g., to transfer incoming/outgoing calls to/from the MS 12 to the SLDNM 11.

The DS 44 is a database for storing information that enables access to and updating of the call status and acknowledgement data of each moving MS 12 in an area associated with the SLDS 30. Data are preferably stored for only each MS 12 whose speed exceeds the threshold. At least two types of data, real time data and acknowledgement data, are stored in the DS 44. Real-time data are updated frequently, and possibly continuously, as a result of services provided by the SNS 42. Acknowledgement data are maintained in the DS 44 for a predetermined amount of time and can be downloaded onto back-up devices for future access and reference.

The SNMS 32 can be activated during four distinct states of the MS 18. These four states are: (1) call setup; (2) MS 12 starts moving above the threshold level while there is a call in progress; (3) the MS 12 initiates an emergency call (911); and (4) the MS 12 receives an emergency call. Call setup includes MS-initiated calls (i.e., the MS 12 attempts to make an outgoing call) and MS-terminated calls (i.e., a party attempts to call the MS 12).

Establishing a cellular telephone call involves two types of signaling to properly connect the call, IS-41 call processing signaling and traditional call control signaling. IS-41 signaling is used to obtain routing information and call treatment for mobile-originated calls. For mobile-terminated calls, IS-41 is used to obtain MS location, status and routing information.

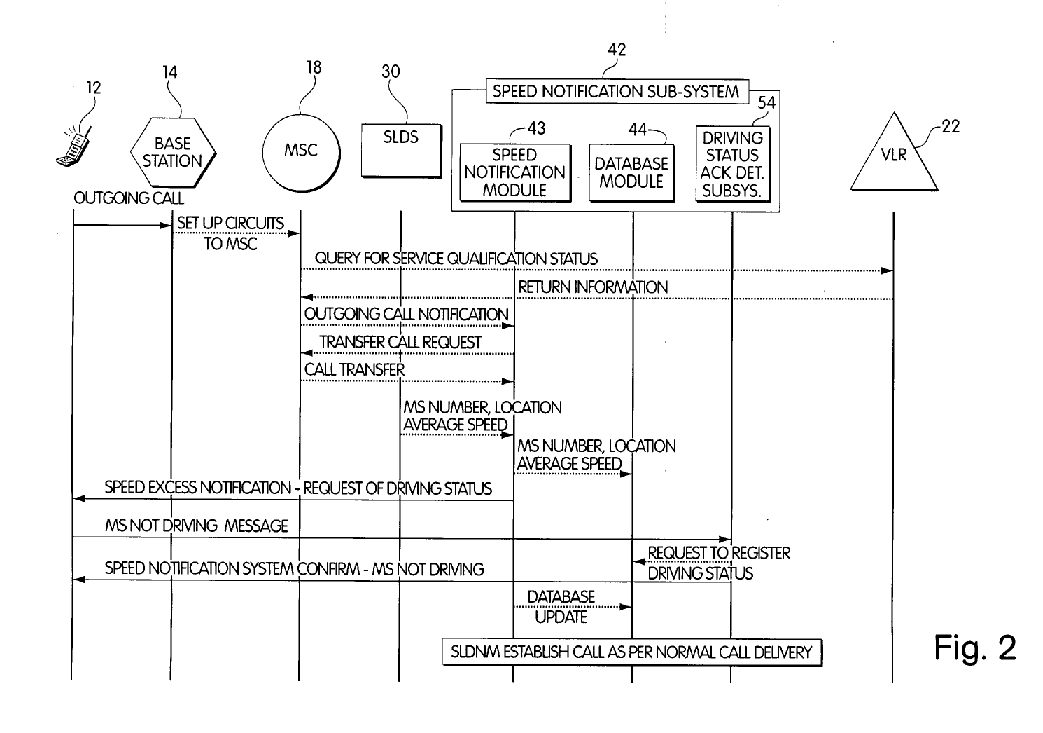

For a mobile-initiated call, calls are established from the MS 12 (the calling party) to a telecommunication termination point (the called party). The called party can be an entity other than a person, e.g., a voicemail or paging system. Referring to FIG. 2, to complete a call, the MS 12 sends an outgoing call to the base station 14. The MS 12 is authenticated for transmission by the base station 14, which sets up a circuit connection with the MSC 16. A query is made by the MSC 16 to a Visitor Location Register (VLR) 22, for the service qualification status of the MS 12. The VLR 22 sends return information to the MSC 16. If the MSC 16 approves the return information, then the calling process proceeds. The MSC 16 sends an outgoing call notification to the SLDNM 11. The SLDNM 11 sends a transfer-call request to the MSC 16, and the MSC 16 transfers the call to the SLDNM 11.

The SLDM 38 determines the speed of the MS 12 and sends this information to the SNS 42. If the SNS 42 determines that the MS 12 is moving at an excessive speed, and given the knowledge that the MS 12 is attempting to initiate a call, then the SNS 42 notifies the user of the MS 12 of the excess speed. This announcement requests confirmation as to whether the user of the MS is driving and can be, e.g., “Your mobile telephone system has identified that you are using your mobile phone and moving at the same time. If you are not the driver, please press *. If you are the driver please press #.” The MS 12 sends the user's response to the announcement to the SNS 42, in particular to the DSADM 54 that interprets the response.

Depending on the user's response to the excessive speed announcement, the SNS 42 takes appropriate action. In FIGS. 2-11, the SNS 42 is shown to include a Speed Notification Module (SNM) 43. The SNM 43 represents the portions of the SNS 42 other than the DSADM 54.

As shown in FIG. 2, if the user responds through the MS 12 that the user is not driving, then the DSADM 54 sends a message to the user confirming that the user is not the driver. An example message is, “We are confirming that you have informed us that you are not the driver. We are storing this information on our database. We are now connecting your call. Thank you for your cooperation.” The SNS 42 establishes the call to the called party. The DSADM 54 sends the user's mobile identification number (MIN) and electronic identification number (EIN) and call information (date, time, and not-driving status of the user) received from the SLDS 30 to the DS 44.

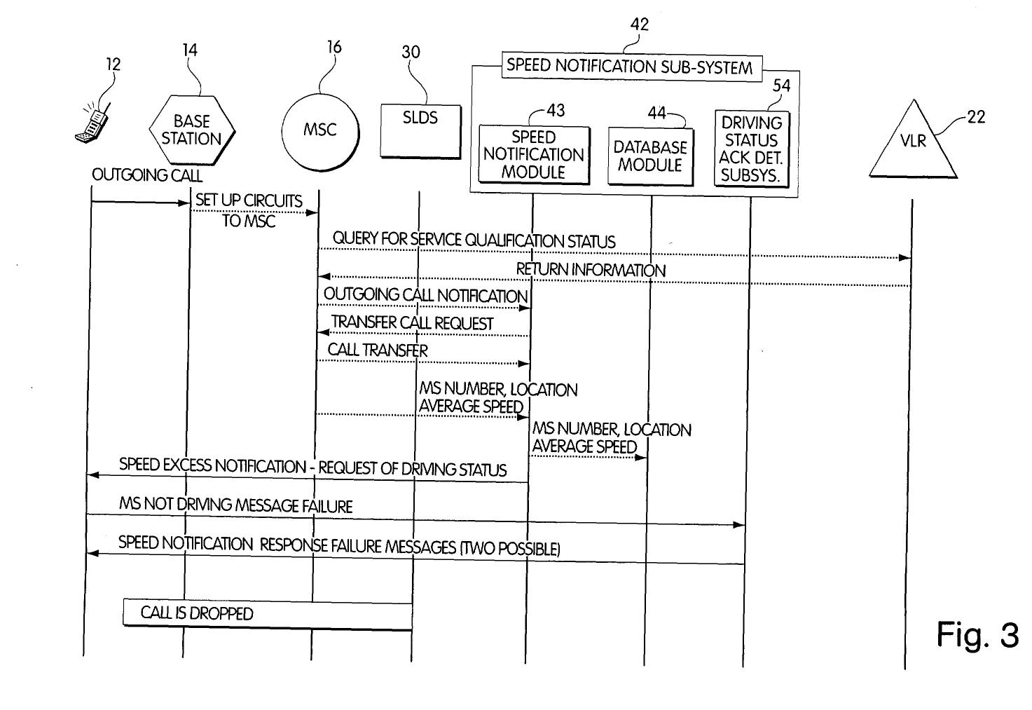

As shown in FIG. 3, if the user fails to respond to the excessive speed announcement, then the SNS 42 sends a voice message to this effect to the MS 12. The message states that the SNS 42 failed to confirm that the user is not a driver and that the call will not be established if the user does not confirm non-driving status of the user. An exemplary message is “You have failed to inform us that you are not the driver. Your call will be disconnected. Please call when you are not driving or press * now to indicate that you are not the driver.” If the user does not press *, then the SNS 42 sends another message to the MS 12 regarding the failure and that the call will not be connected. An exemplary message is, “You have failed to inform us that you are not the driver. The call will not be completed at this time.” In response, the SLDNM 11 will not establish the requested call.

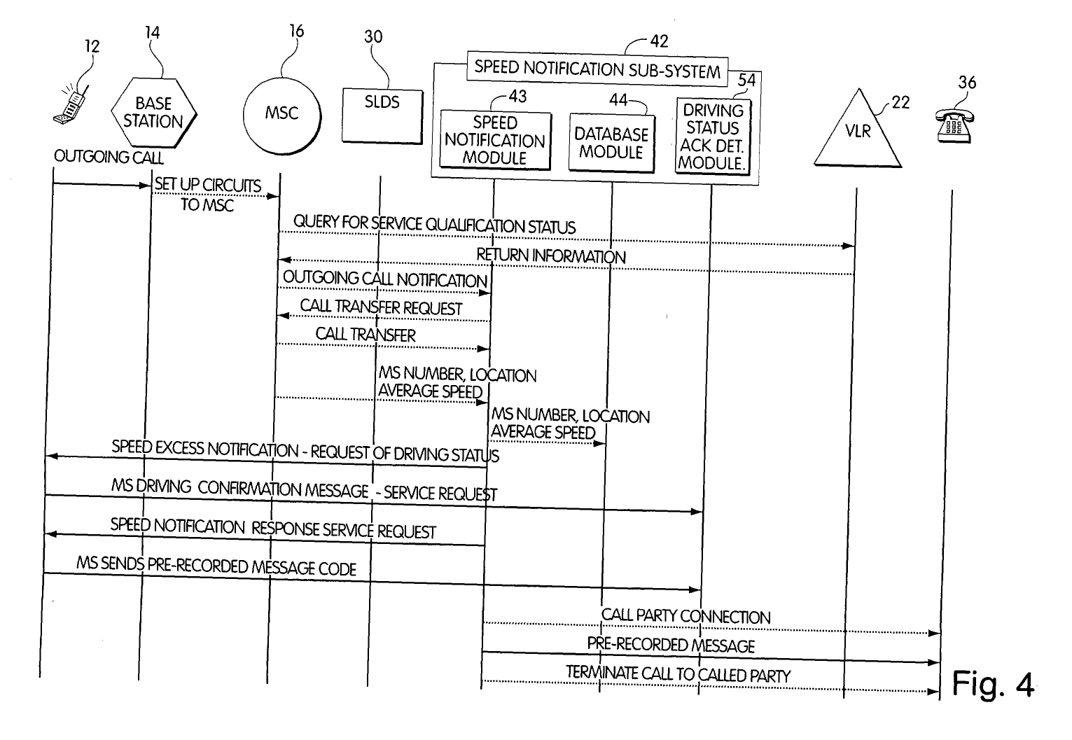

As shown in FIG. 4, if the user responds to the excessive speed notification by confirming that the user is driving, then the SNS 42 sends a voice message to the MS 12 confirming that the user has acknowledged being the driver and that the call will not be completed. An exemplary message is, “You have confirmed that you are driving now. Your call will not be connected. We can forward a message for your called party provided that you prerecorded your messages. To send pre-recorded messages press # and the number of your prerecorded message that you would like to forward. Otherwise, please call when you are not driving.” If sending a pre-recorded message is not selected, then the SLDNM 11 does not proceed with establishing the call. The message sent by the MS 12 is pre-stored in memory (e.g., by the user or possibly by the manufacturer of the MS 12) and can be of a predetermined length, e.g., 10 seconds, according to the amount of memory allocated for the messages. If sending a pre-recorded message is selected, then the SLDNM 11 establishes a call to the called party, e.g., the phone 36. The SLDNM 11 retrieves the user's selected messages from memory and transmits the message toward the called party. After delivery of the message, the SLDNM 11 terminates the call.

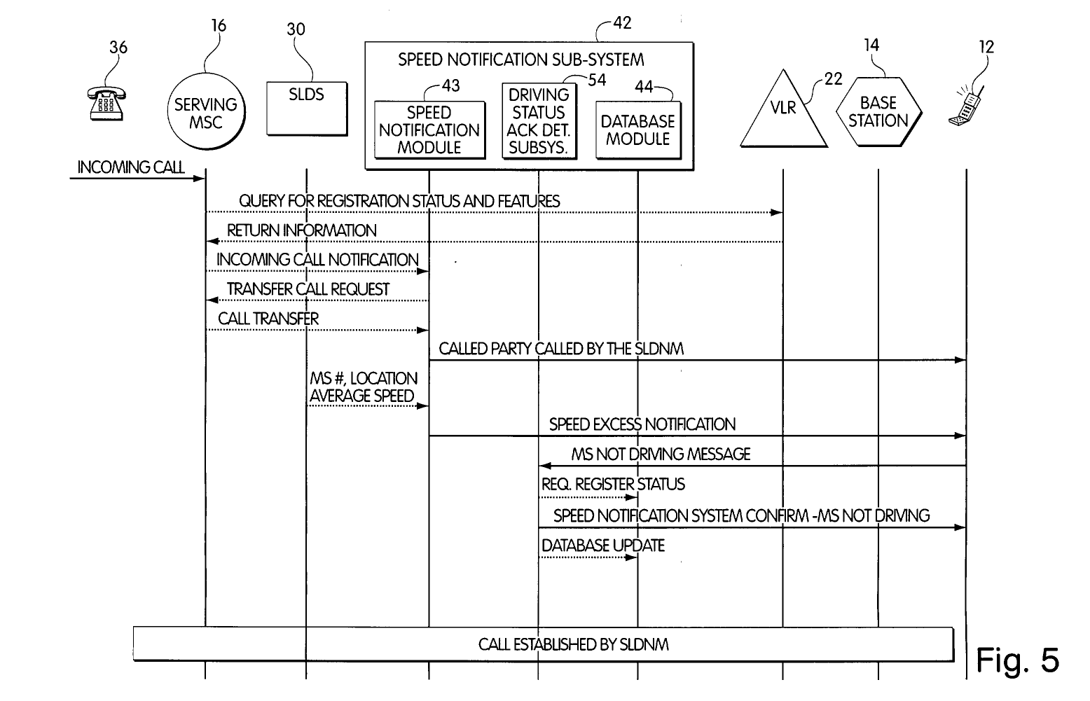

Referring to FIG. 5, in the case of a mobile-terminated call, a call is made to a user's MS 12 from, e.g., the telephone 36. In this case, the user of the MS 12 is the called party. When a user is being served by the same MSC 16 as the one where the incoming call arrives, no location information or special signaling or routing is required. The delivery of mobile-terminated calls to a roaming user is a call feature known as “call delivery” and it is addressed in the IS-41 standard. A query is made by the serving MSC 16 to the VLR 22 for registration and status features and the VLR 22 provides return information.

The MSC 16 sends an incoming-call notification to the SLDNM 11. The SLDNM 11 sends a request for call transfer to the MSC 16. In response, the MSC 16 transfers the call to the SLDNM 11. The SLDNM 11 establishes a call to the called party, e.g., the MS 12. The SLDS 30 determines whether the speed of the MS 12 is excessive, and the SNS 42 determines the call status.

If the SLDS 30 determines that the MS 12 is moving at an excessive speed, then the SNS 42 sends an announcement to the MS 12 regarding excessive speed. This announcement requests confirmation as to whether the user of the MS is driving and can be, e.g., “You are receiving a call from [phone ID]. However, your mobile telephone system has identified that you are moving by means of a vehicle. If you are not the driver, then please press *. If you are the driver and would like to forward a message to the calling party please press # and another digit for your pre-recorded messages.” The SNS 42 also sends a voice message to the calling party warning to stay connected. This message can be, e.g., “The other party is talking and moving at the same time. This could be against [e.g., the law; our policy]. Please stand by while a check is made as to whether the other party is driving. If this is an emergency, please press #* and your call will be connected and a record of this call will be kept on our database.” If the calling party indicates that the call is an emergency, then the call is processed as discussed below for an emergency call. The MS 12 sends the user's response to the announcement to the SNS 42.

As shown in FIG. 5, if the user responds through the MS 12 that the user is not driving, then the SNS 42 sends a message to the user confirming that the user is not the driver. An example message is, “We are confirming that you have informed us that you are not the driver. We are storing this information on our database. We are now connecting your call. Thank you for your cooperation.” The SLDNM 11 establishes the call between the calling and called parties, e.g., the phone 36 and the MS 12. The DSADM 54 sends the user's mobile identification number (MIN) and electronic identification number (EIN) and call information (date, time, and not-driving status of the user) received from the MSC 16 to the DS 44.

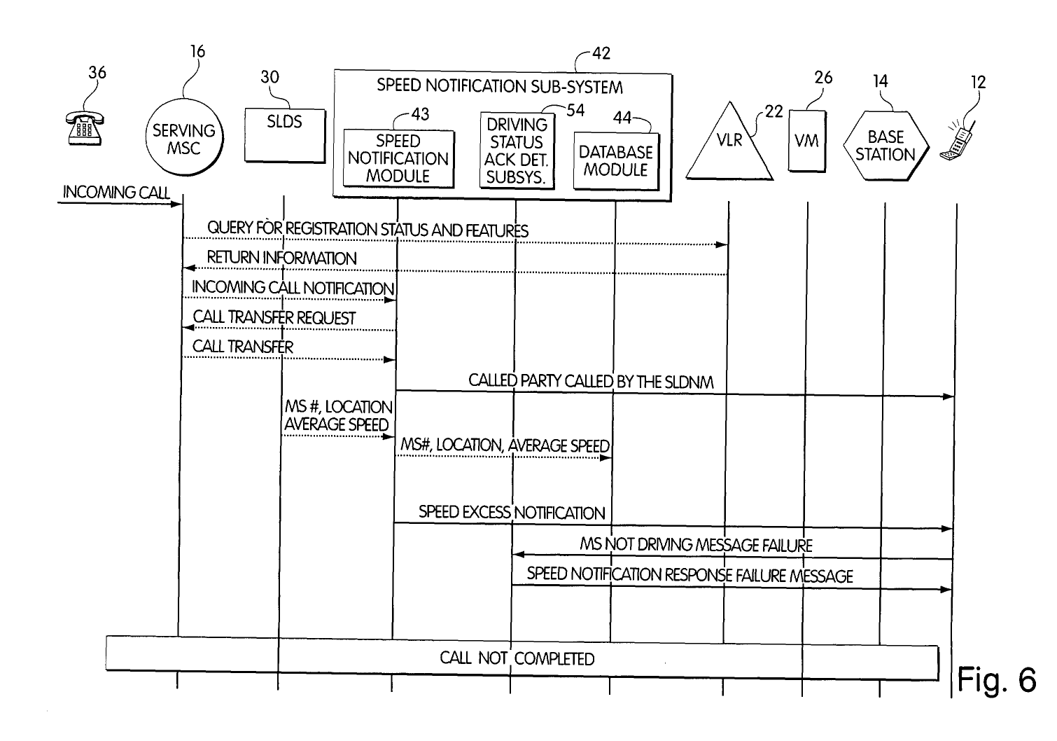

As shown in FIG. 6, if the user fails to respond to the excessive speed announcement, then the SNS 42 sends a voice message to this effect to the MS 12 and to the calling party. The message to the MS 12 states that the SNS 42 failed to confirm that the user is not a driver and that the call will not be established. An exemplary message is “You have failed to inform us that you are not the driver. The call will not be completed at this time.” The SNS informs the calling party that the call will not be connected. For example, the SNS 42 can send the following to the calling party, “The party you have called has failed to indicate whether the party is currently driving, and thus it is assumed that the called party is driving. As it is against [e.g., the law; our policy] to use a mobile phone will driving, the call will not be established.” The call is dropped by the SLDNM 11.

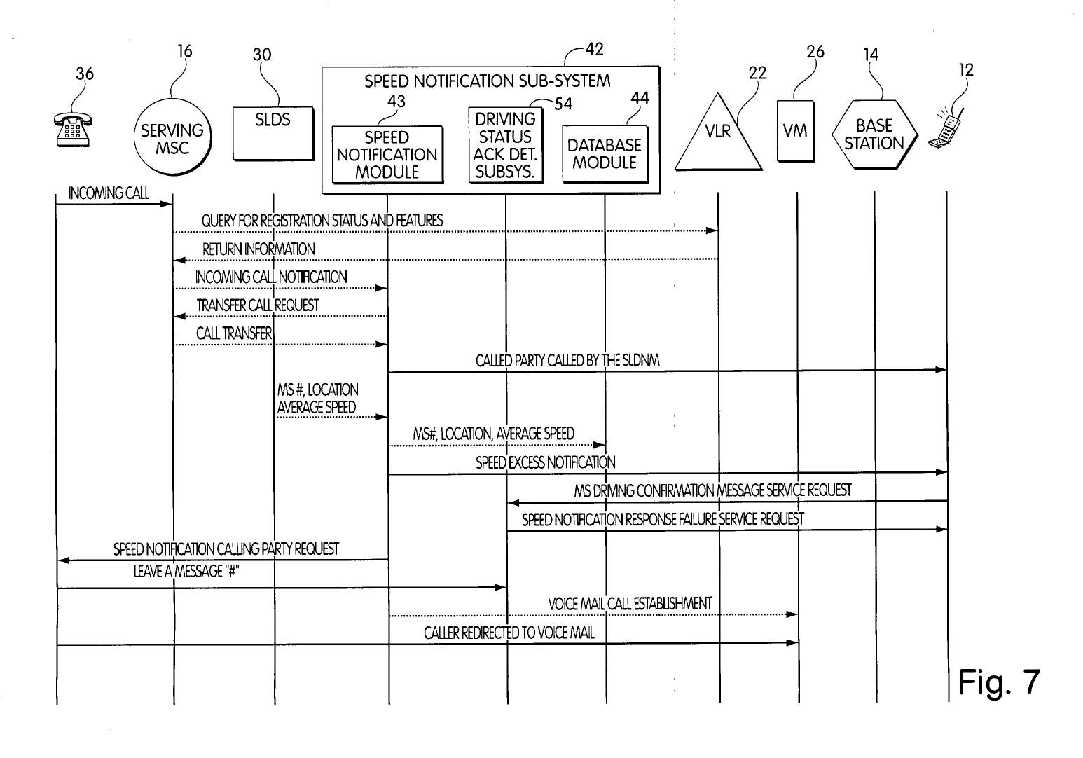

As shown in FIG. 7, if the user responds to the excessive speed notification confirming that the user is driving, then the SNS 42 sends a voice message to the MS 12 confirming that the user has acknowledged being the driver and that the call will not be completed. An exemplary message is, “You have confirmed that you are currently driving. As it is against [e.g., the law; our policy] to use a mobile phone while driving, the call will not be established at this time. If you would like to forward a message to the calling party, please press # and the number of your pre-recorded message that you would like to forward. If you would like to transfer the call to your preselected forwarding destination, please press *.” If the user of the called MS 12 chose to forward a message to the calling party, then the SNS 42 informs the calling party that the call will not be connected, as discussed below, retrieves the message indicated by the called MS 12 from memory, and forwards this message to the calling party.

If the called party selected to transfer the call to a preselected forwarding destination, then the SLDNM 11 transfers the call to the phone number preselected by the user. The SLDNM 11 looks up the phone number in memory. Several phone numbers may be stored in memory corresponding to, e.g., the user's home, work, pager, voicemail, or a message center with a pool of attendants that can record a message and send it to the user, for example through the MS 12 at a later time. Which phone number to use can be determined, e.g., according to the time of day and day of the week. The SNS 42 sends a message to the calling party that the called party is driving and that the call is being forwarded. This message can be, e.g., “The party you called is currently driving. As it is against [e.g., the law; our policy] to drive while using a mobile phone, your call cannot be completed now. Your call will be forwarded to a destination selected by the party that you called.”

Some MS's 12 can accept a recorded message from the calling party. If the called MS 12 can accept messages, then the SNS 42 sends a voice message to the calling party informing the calling party that the called party is driving, and gives the calling party a chance to record a voice message to the called MS 12. The message sent to the calling party can be, e.g., “The party you have called is currently driving. As it is against [e.g., the law; our policy] to use a mobile phone will driving, the call will not be established at this time. Please press # to leave a brief message, or try your call later.” If the calling party chooses to leave a message, then the SLDNM 11 establishes a call to a voicemail (VM) system 26. Once the speed of the MS 12 is reduced below the threshold for more than a predetermined number of minutes (or otherwise appears not to be moving in an undesired way), the system 10 initiates a call to forward and deliver all messages. No message waiting indication is presented to the user at the MS 12 while the MS 12 appears to be moving in an undesired way, such as moving faster than the threshold.

If the called MS 12 does not accept messages, then the SNS 42 sends a voice message to the calling party informing the calling party that called party is driving, and that the call will not be completed. For example, the message sent to the calling party may be, “The party you called is currently driving. As it is against [e.g., the law; our policy] to drive while using a mobile phone, your call cannot be completed now.”

If the calling party does not indicate that the call is an emergency and the call is not forwarded by the called party, then the SLDNM 11 drops the call. This is preferably performed after the called party chooses whether to forward a message, and if so selects which message, and preferably after the calling party leaves a message, if any.

For “Call In Progress” situations, at least one MS 12, referred to as the A side, is taking part in a call. The other party, referred to as the B side, may or may not be a mobile station. In the Call In Progress situation, both parties are connected and the call is under the control of the SLDNM 11 when it is detected that the MS 12 starts moving in a way that indicates that the MS 12 may be being used by a person that is driving. For example, the MS 12 may be moving excessively fast, e.g., above a threshold level.

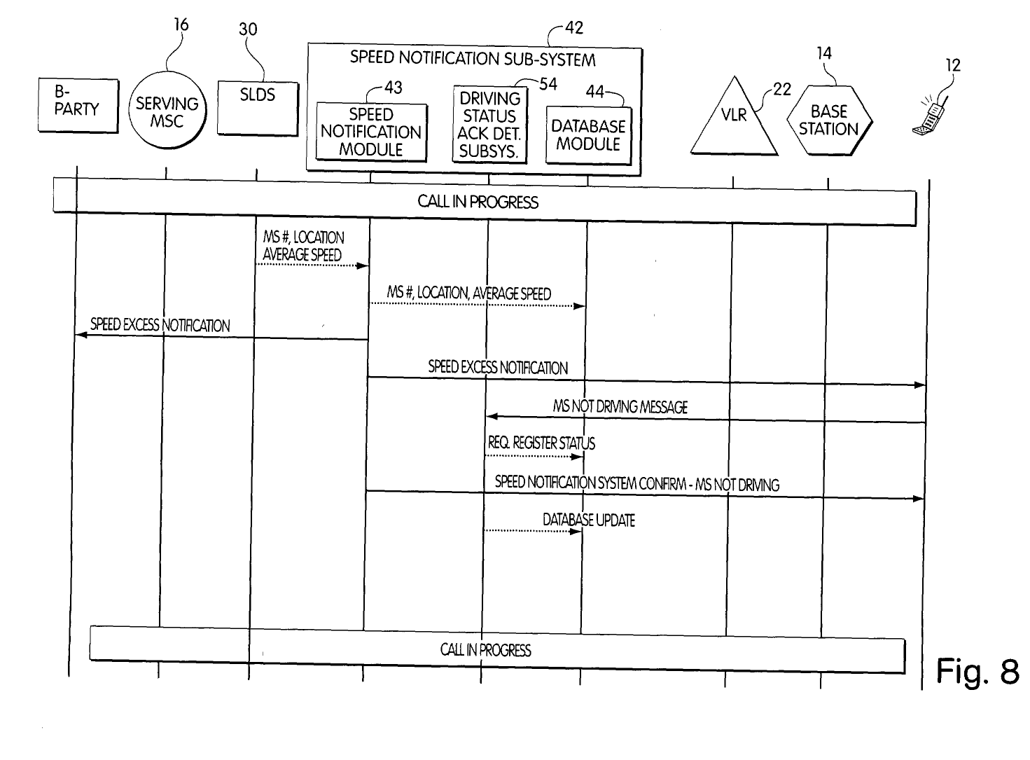

Referring to FIG. 8, the SNS 42 determines whether a party to a call in progress may be driving. The SLDS 30 determines whether the speed of the MS 12 is excessive. If the SNS 42 receives an indication from the SLDS 30 that the speed of the MS 12 is excessive, and determines that the call status of the MS 12 is active, then the SNS 42 interrupts the call.

The SNS 42 sends announcements to both parties regarding the excessive speed of the MS 12. An A-side announcement to the MS 12 requests confirmation as to whether the user of the MS 12 is driving and can be, e.g., “Your mobile telephone system has identified that you are using your mobile phone and moving at the same time. If you are not the driver, please press *. If you are the driver please press #. If this is an emergency, then please press #* and your call will be reconnected and a record of this call will be kept on our database.” If the A-side party indicates that the call is an emergency, then the call is processed as discussed below for an emergency call. The B-side announcement requests the B-side party to stay connected. This message can be, e.g., “The party with whom you are talking is talking and moving at the same time. This could be against [e.g., the law; our policy]. Please stand by while a check is made as to whether the party with whom you are talking is driving. If this is an emergency, then please press #* and your call will be reconnected and a record of this call will be kept on our database.” If the B-side party indicates that the call is an emergency, then the call is processed as discussed below for an emergency call. The MS 12 sends the user's response to the A-side announcement to the SNS 42.

If the user responds through the MS 12 that the user is not driving, then the SNS 42 sends a message to the user confirming that the user is not the driver. An example message is, “We are confirming that you have informed us that you are not the driver. We are storing this information on our database. We are now reconnecting your call. Thank you for your cooperation.” The SNS 42 sends the user's mobile identification number (MIN) and electronic identification number (EIN) and call information (date and time) received from the MSC 16 to the DS 44. The call is re-established and call features are reapplied.

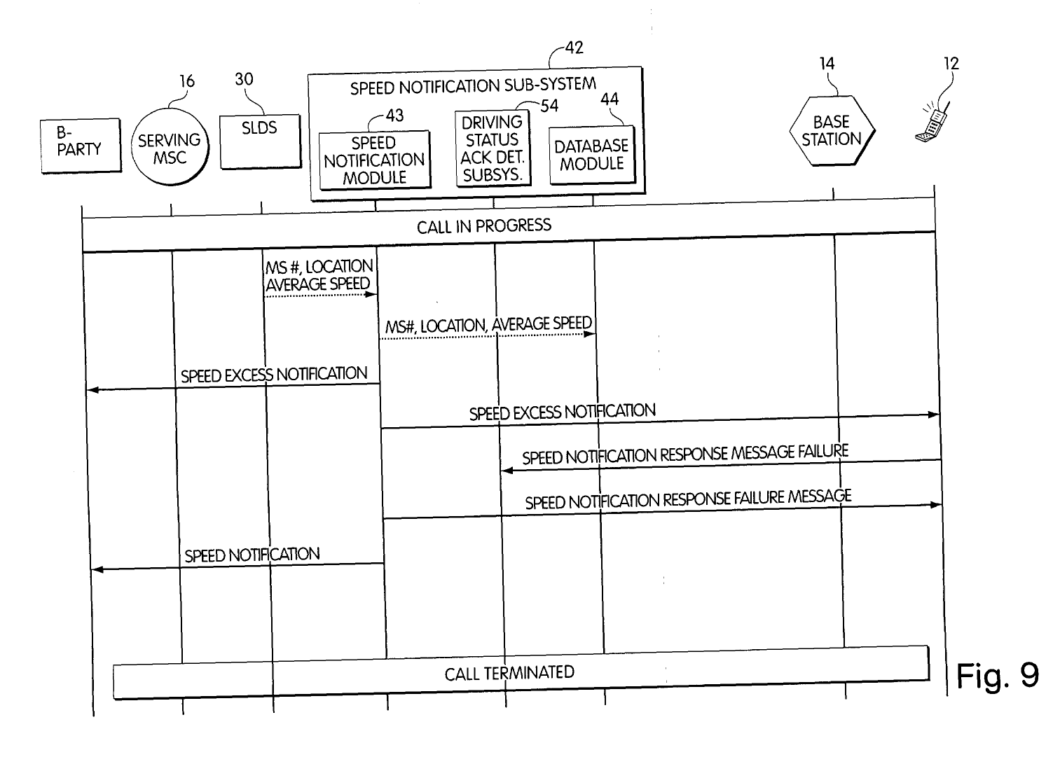

As shown in FIG. 9, if the user fails to respond to the excessive speed announcement, then the SNS 42 sends a voice message to this effect to the MS 12 and to the B-side party. The message to the MS 12 (A-side party) states that the SNS 42 failed to confirm that the user is not a driver and that the call will be disconnected. An exemplary message is “You have failed to inform us that you are not the driver. The call will be disconnected at this time.” The SNS informs the B-side party that the call will be disconnected. For example, the SNS 42 can send the following to the B-side party, “The party with whom you were talking has failed to indicate whether the party is currently driving, and thus it is assumed that the called party is driving. As it is against [e.g., the law; our policy] to use a mobile phone will driving, the call will be disconnected.” The SLDNM 11 disconnects the call.

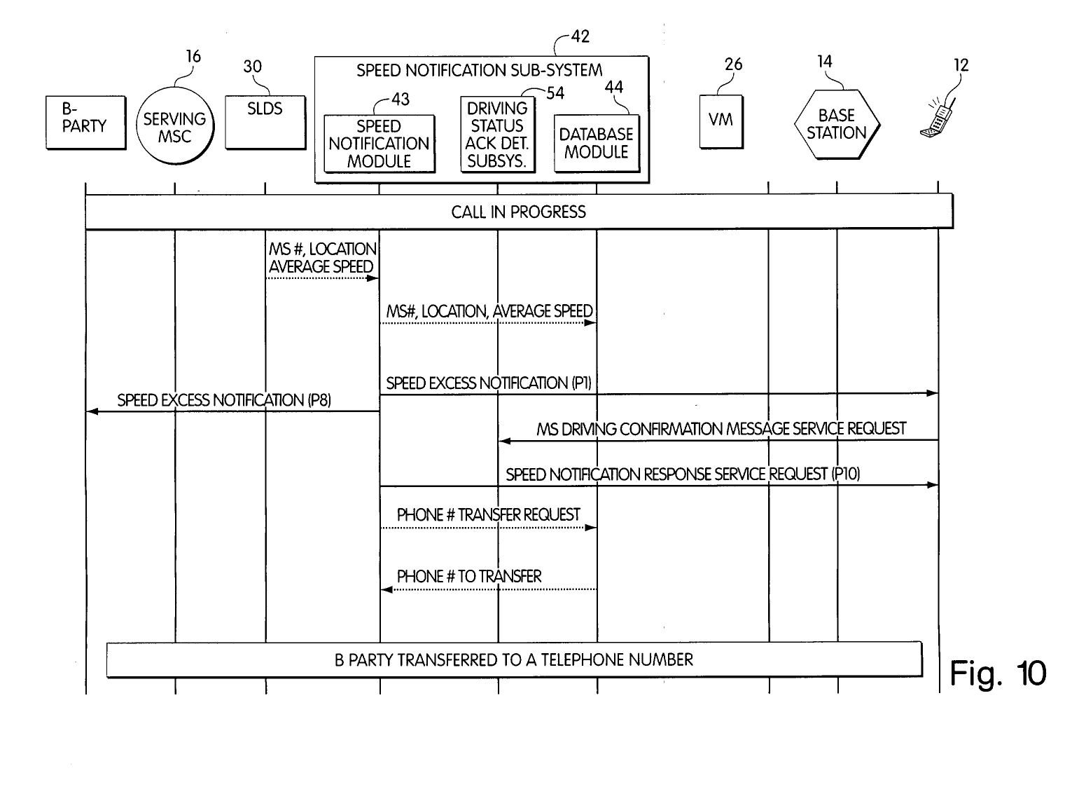

As shown in FIG. 10, if the user (A-side party) responds to the excessive speed notification confirming that the user is driving, then the SNS 42 sends a voice message to the MS 12 confirming that the user has acknowledged being the driver and that the call will be terminated. An exemplary message is, “You have confirmed that you are currently driving. As it is against [e.g., the law; our policy] to use a mobile phone while driving, the call will be disconnected at this time. If you would like to forward a message to the other party, please press # and the number of your pre-recorded message that you would like to forward. If you would like to transfer the call to your preselected forwarding destination, please press *.” If the A-side party chose to forward a message to the B-side party, then the SNS 42 informs the B-side party that the call will be disconnected, as discussed below, and the SNS 42 retrieves the message indicated by the A-side party from memory and forwards this message.

If the called party selected to transfer the call to a preselected forwarding destination, then the SLDNM 11 transfers the call to the phone number preselected by the user. The SLDNM 11 looks up the phone number in memory. Several phone numbers may be stored in memory corresponding to, e.g., the user's home, work, pager, voicemail, or a message center with a pool of attendants that can record a message and send it to the user, for example through the MS 12 at a later time. Which phone number to use can be determined, e.g., according to the time of day and day of the week. The SNS 42 sends a message to the B-side party that the A-side party is driving and that the call is being forwarded. This message can be, e.g., “The party with whom you were talking is currently driving. As it is against [e.g., the law; our policy] to drive while using a mobile phone, your call will be forwarded to a destination selected by the party with whom you were talking.”

If the MS 12 of the A-side party can accept messages, then the SNS 42 sends a voice message to the B-side party informing the B-side party that the A-side party is driving, and gives the B-side party a chance to record a voice message to the A-side party. The message sent to the B-side party can be, e.g., “The party with whom you were talking is currently driving. As it is against [e.g., the law; our policy] to use a mobile phone will driving, the call will be disconnected at this time. Please press # to leave a brief message, or try your call later.” If the B-side party chooses to leave a message, then the SLDNM 11 will transfer the call to the VM system 26. In response to the speed of the MS 12 being reduced below the threshold for more than a predetermined number of minutes (or otherwise appears not to be moving in an undesired way), the system 10 initiates a call to forward and deliver all messages. No message waiting indication is presented to the user at the MS 12 while the MS 12 appears to be moving in an undesired way, such as moving faster than the threshold.

If the MS 12 of the A-side party does not accept messages, then the SNS 42 sends a voice message to the B-side party informing the B-side party that the A-side party is driving and that the call will be disconnected. For example, the message sent to the calling party may be, “The party you called is currently driving. As it is against [e.g., the law; our policy] to drive while using a mobile phone, your call will be disconnected now. If this is an emergency, then please press #* and your call will be reconnected and a record of this call will be kept on our database.” If the B-side party indicates that the call is an emergency, then the call is processed as discussed below for emergency calls.

If the B-side party does not indicate that the call is an emergency and the call is not forwarded by the A-side party, then the SLDNM 11 drops the call. This is preferably performed after the A-side party chooses whether to forward a message, and if so selects which message, and preferably after the B-side party leaves a message, if any.

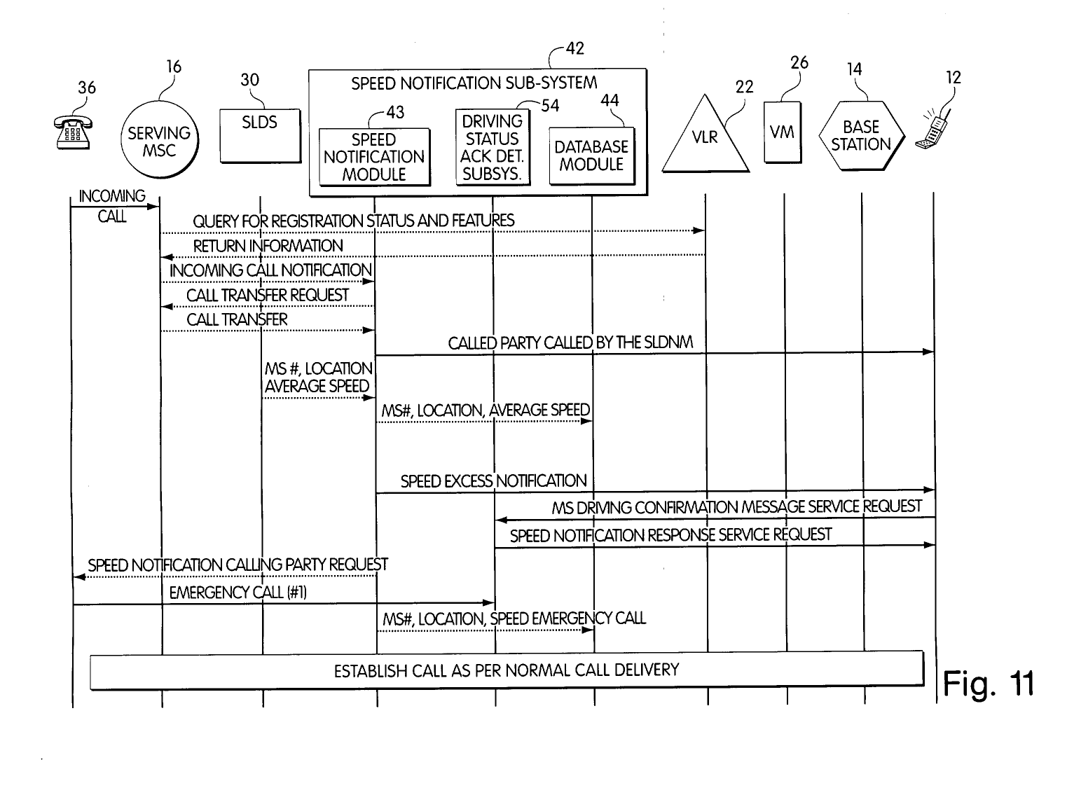

There are mobile calls that should be treated as exceptional cases, such as emergency situations. For example, when a user of an MS dials a predetermined number such as 911 to obtain help, this can be recognized as an emergency situation. In this case, the SLDNM 11 will not inhibit connection or reconnection of a call. The SNS 42 sends appropriate messages to the MS user that is driving. For example, if the MS user that is driving indicates that a current call being initiated or in progress is an emergency, then the SNS 42 can send, “You have indicated that this is an emergency call. Please stop driving as soon as practical at a safe place. All emergency calls are registered for safety and security purposes.” Also, for example, if the party other than the MS user that is driving (although the other party could also be an MS user) indicates that a current call being initiated or in progress is an emergency, the SNS 42 can send, “The other party has indicated that this call is an emergency. Please stop driving as soon as practical at a safe place. All emergency calls are registered for safety and security purposes.” As shown in FIG. 11, the MS 12 receives a call, the MS user confirms that the MS user is driving, and the other party indicates that the call is an emergency. The SLDNM 11 will connect/reconnect the call to the MS 12 as the case may be. The SNS 42 sends the user's mobile identification number (MIN) and electronic identification number (EIN) and call information (date and time) received from the MSC 16, and an indication that the call is an emergency call, to the DS 44.

Other embodiments are within the scope of the invention. For example, the ability to leave a message can be added to the situations discussed above in which this ability is not specifically referred to, and can be removed from the situations in which this ability is referred to. Also, regardless of whether the user of the MS 12 is driving, the speed of the MS 12 can be registered (e.g., stored in the DS 44). If the speed of the MS 12 is consistently above a predetermined speed (e.g., a legal limit), then the speed can be registered and the user notified. The calling party may be given the option to leave a message if the called party fails to respond to the inquiry as to whether the called party is driving. Communication from the MS 12 can also be routed through a PSTN. Also, the cost of a call can be altered depending on the call status and the user's response, or lack thereof, to the driving status inquiry. The user can be given the option to designate an incoming call as an emergency call.

A service could be provided for law enforcement organizations, e.g., identifying the user's location, identity, and speed. This could produce millions of dollars in additional traffic violation revenue, reduce the usefulness of radar detectors for drivers, and increase safety due at least in part to a reduction in the speed at which some drivers drive. This service could be accomplished, e.g., by interfacing with a positioning system (for identification of the geographical position by means of the cell-phone or, e.g., a global positioning system (GPS)). Also, the user could be notified of excessive speed to help reduce the user's risk of receiving a speeding ticket or other traffic violation citation.

The threshold used to determine that a user of an MS may be driving may vary between persons. For example, if the user drives heavy machinery such as construction equipment, then the threshold speed may be reduced for that user.

Also, while components of the system 10 have been described as software that includes computer-readable instructions for causing a computer to perform certain functions, these functions can be implemented using software, hardware, hardwiring, firmware, or combinations of any of these and can be located in the system 10 in places other than those shown and described.

The SNS 42 could query a user of the MS 12 that is driving as to when the user will not be driving. The user's response can be provided to the other party to the call as part of a message, or as an independent message, sent to the other party so that the call can be attempted again after the time indicated by the user of the MS 12.

Various options are possible for how the user responds to the driving status inquiry. For example, the user may be required to depress two keys on a mobile phone for a period of time, e.g., three seconds, in order to indicate that the user is not driving.

Also, an inactive MS that is not in use, and not trying to be used, to transmit or receive voice communications or other data by a user, can be monitored and its motion status (e.g., likely to be travelling in a motor vehicle) determined. This can be used, e.g., for an MS that is moving above a predetermined speed to then register the MS's status and notify the user and/or to identify the user's location, identity, and speed, e.g., to law enforcement personnel.

As discussed above, a GPS may be used to help determine location, identity, and/or speed of an MS. A portion of the GPS could thus reside in the MS. Some MSs include GPS functionality due to mandate E-911 by the Federal Communications Commission. The MS can store messages as discussed above for interaction with the user and can act upon replies by the user independently of other devices (e.g., shown in FIG. 1). This can be true even if the MS does not include GPS functionality.

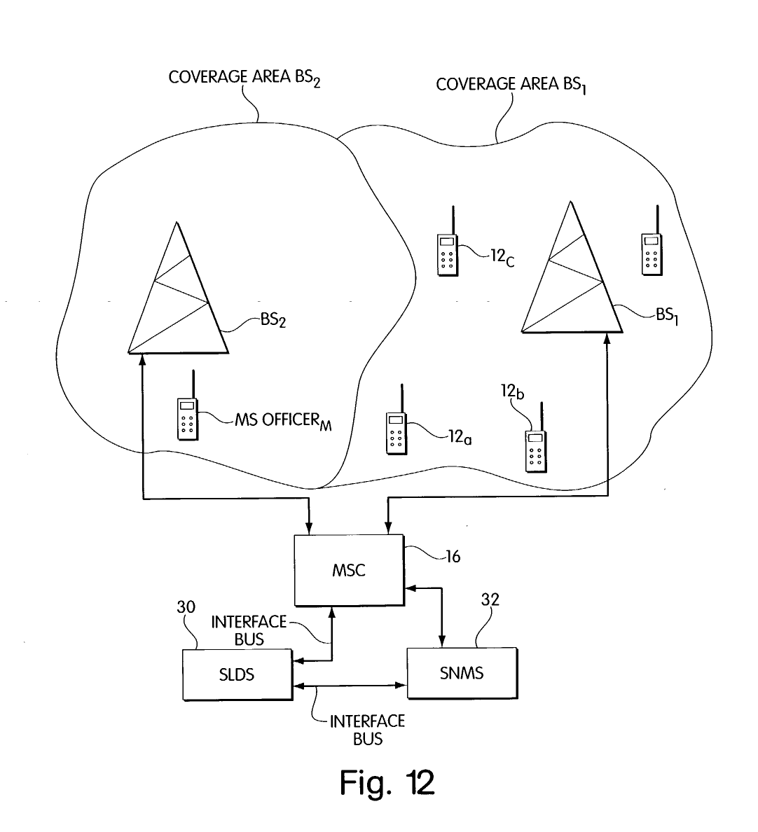

The location of the MS can be ascertained by the SLDS 30 using a GPS, or using other techniques such as the local cellular phone processing stations. Using the location of the MS, calls to, e.g., local police, fire stations, paramedics, and/or hospitals can be made by the SNMS 32, e.g., the SLDS 30 and the MSC 16. This can reduce reaction times for these persons/entities to respond when needed, e.g., when the user of the MS initiates a “911 call.” The user may be connected to one or more of the persons/entities such as the police and/or a hospital or a 911 attendant (e.g., at a console of a local, preferably the nearest, police station) through, e.g., the BS 14, the MSC 16, the PSTN 34, and the phone 36. Referring to FIG. 12, the SLDS 30 communicates with the SNMS 32 and the MSC 16 through interface buses. The SNMS 32 and the MSC 16 transmit signaling information and notification and messaging information between each other. The SLDS 30 thus receives information regarding MS status and location. The SLDS 30 uses the information received to determine the closest MSs, here MS 12a and MS 12b to an MS 12c that is making an emergency call. The MSs 12a and/or 12b can be operatively connected to the MS 12c for communication or otherwise alerted to take appropriate action such as going to the location of the MS 12c that can be provided to the MSs 12a and 12b by the SLDS 30.

Still other embodiments are within the scope and spirit of the appended claims.

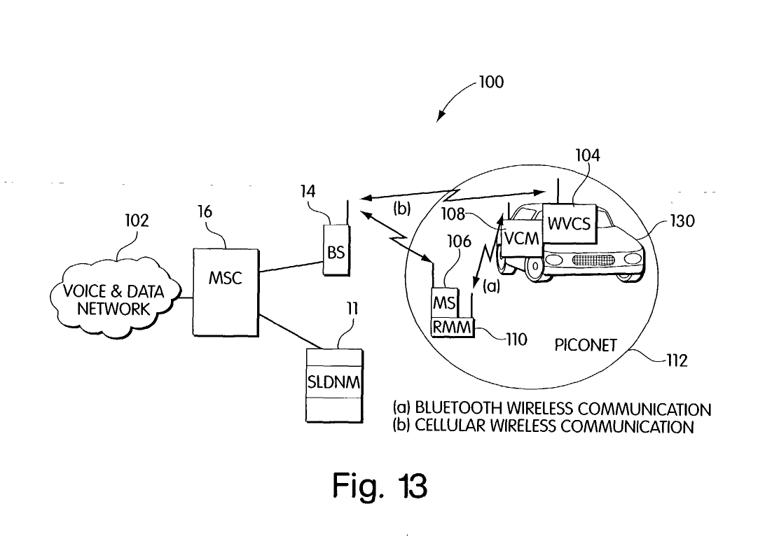

Referring to FIG. 13, a system 100 includes the BS 14, the MSC 16, a voice/data network 102 (e.g., the PSTN 34), the SLDNM 11, a Wireless Vehicle Communication System (WVCS) 104, and a Wideband Wireless Mobile Station 106. The WVCS 104 includes a Vehicle Control Module (VCM) 108 and the MS 106 is housed together with a Remote Mobile Module (RMM) 110. The MS 106 and the WVCS 104 are configured to communicate with the BS 14, e.g., using cellular communication. The MS 106 and the WVCS 104 can thus communicate with the SLDNM 11 to provide the services described above to communications with the MS 106. The VCM 108 is configured to communicate with the MS 106 through the RMM 110 to configure the MS 106 as to which services the MS 106 will receive and how those services will be provided. The VCM 108 and the RMM 110 are configured to communicate wirelessly with each other, and other devices, according to the Bluetooth™ protocol.

The Bluetooth protocol is based on an open specification for short-range wireless voice and data communication. Version 1.0 of Bluetooth provides for a bandwidth limit of 1.0 MHz per channel, with over 79 channels in many countries, and uses a Frequency Hopping Spread Spectrum technique. With two devices communicating according to the Bluetooth protocol, one device acts as the master and the other device acts as a slave. The master device defines the frequency hopping pattern and the frequency phase for the communication. A master can communicate concurrently with up to 7 active slaves and up to 255 parked slaves. All slaves communicating with a master hop together in unison with the master. The slaves and the master form a piconet, e.g., the piconet 112 including the VCM 108 and the RMM 110. In the piconet 112, the VCM 108 initially acts as the master and any MS equipped with RMM will initially act as a slave to the VCM 108.

The Bluetooth protocol includes a protocol stack. This stack provides for devices to locate, connect to, and exchange voice and data with other devices. The stack also provides for devices to execute interoperable applications (i.e., applications that are executable on either device) and interactive applications with each other. In the system 100, the VCM 108 and the RMM 110 can communicate without action by a user of either the MS 106 or the WVCS 104, and without indication to a user of either device that the communication is occurring.

Elements of the Bluetooth protocol stack, e.g., protocols, layers, applications, are divided into a transport protocol group, a middleware protocol group, and an application protocol group. The transport group includes protocols that help Bluetooth devices locate each other and configure, produce, and manage both physical and logical links. The system 100 uses the transport group transparently to users of Bluetooth-equipped devices. The middleware protocol group includes additional transport protocols, Internet-related protocols (e.g., PPP, IP, TCP), wireless-application protocols, object-exchange protocols, a serial port emulator protocol (RFCOMM), a packet-based telephony control signaling protocol, and a service discovery protocol. The RFCOMM protocol is used by the system 100 for legacy applications to operate using Bluetooth transport protocols and to transmit data among the VMC 108 and the RMM 110. The packet-based telephony control protocol is used by the system 100 to provide control of telephony operations. The service discovery protocol is used by the system 100 for devices to learn each other's services and to obtain information about how to access these services. The applications protocol group includes specific applications that use the Bluetooth link. Both the VCM 108 and the RMM 110 are applications that reside at the application layer.

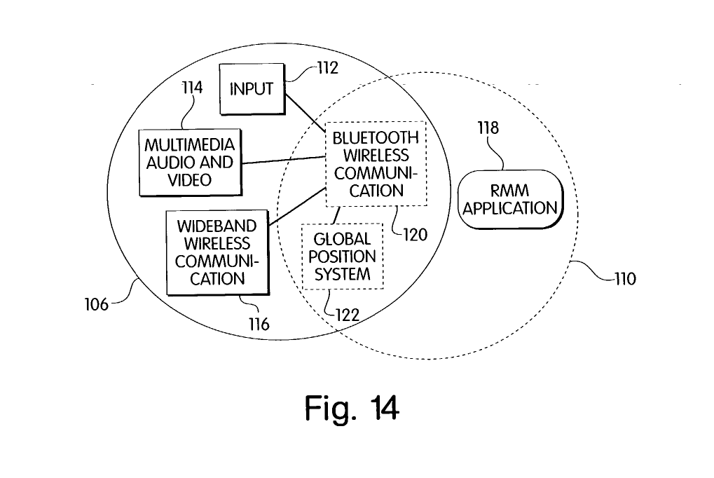

The MS 106 is a device that is configured to exchange messages with other devices, preferably wirelessly using Bluetooth technology. The MS 106 is preferably a portable, wideband, third-generation mobile communication system. As such, the MS 106 would include GPS and Bluetooth functionality. GPS functionality can be used by the MS 106 to determine the location of the MS 106. For example, the MS 106 can be a cellular telephone, a laptop computer, or a Personal Digital Assistant (PDA). Referring to FIG. 14, the MS 106 includes an input 112 such as a keypad, a multimedia audio and video (A/V) device 114 for controlling devices such as a microphone, a speaker, and a display (e.g., an LCD) and a wideband wireless communication unit 116 for long-range communication and the RMM 110 includes an RMM software application 118 that controls the RMM functions. The application 118 can be imbedded in a Bluetooth module 120. The Bluetooth module 120 can be implemented with an Ericcson Bluetooth module ROK101007 (made by Telefonaktiebolaget LM Ericsson Corp. of Stockholm, Sweden), or with Intel's Bluetooth module. As shown, either the MS 106 or the RMM 110 can include the Bluetooth module 120 and/or a GPS 122. If the Bluetooth capabilities are in the MS 106, then the RMM application 118 will reside in the MS 106. Otherwise, the RMM application 118 resides in an RMM host module.

Other forms of the MS 106, however, are acceptable. For example, the MS 106 can be a device other than a third-generation mobile communication device, may not include GPS, and may not have wideband capabilities.

The RMM 110 includes a host module, an audio interface, and an external devices interface. The host module implements the middleware layer of the Bluetooth protocol and the RMM application 118. The host module can be implemented using a microcontroller such as an Intel® KU80386EXTC, RAM, ROM, FLASH EPROM, and logical circuits to implement USB interface connection with the Bluetooth module 120. The audio interface module provides analog-to-digital and digital-to-analog conversion and encoding of audio signals from the MS 106 to the Bluetooth module 120 using PCM and CVSD coding schemes according to the Bluetooth specification. The audio interface can be implemented using commercially available CODEC chipes such as AM79021QJC made by Advanced Micro Devices, Inc. (AMD) of Sunnyvale, Calif., or TP3071 made by National Semiconductor Corp. of Santa Clara, Calif. The external devices interface provides connectivity between the host module and the MSs using interfaces such as USB or an MS-proprietary interface, and is implemented with commercially available components.

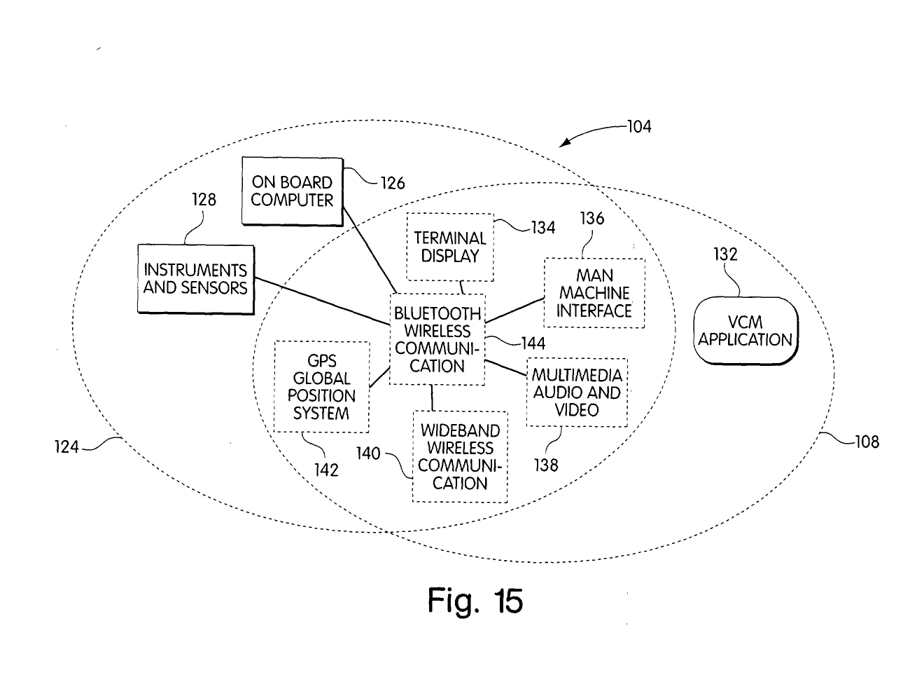

Referring to FIG. 15, the WVCS 104 includes a vehicle device portion 124 and the VCM 108. The portion 124 includes an on-board computer 126 and instruments and sensors 128. The computer 126 and the instruments and sensors 128 can control, e.g., ignition, fuel injection, and braking and can measure/detect, e.g., speed and temperature and can inform/advise/warn a user of a vehicle (e.g., a car 130 shown in FIG. 13) regarding vehicle conditions. The VCM 108 includes a VCM software application 132 that controls the VCM 108. Referring also to FIG. 13, the VCM can intercept calls to/from the BS 14 and the MS 106 and provide services to parties to the calls, or intervene at the MS 106 without intercepting calls. The VCM 108 can receive information from the portion 124 such as vehicle speed, whether vehicle doors are open, whether the vehicle 130 is moving, if the vehicle's parking brake is engaged, and whether the vehicle's gear selector is in park and for how long. Using this information, the VCM 108 can determine whether to inhibit connection of a call or other communication (e.g., a message) to/from the MS 106 or whether to provide other services and if so which service(s) to provide. The VCM 108 operates with a transmitter power of about 1 milliwatt, which is typical of Bluetooth radio. The VCM 108 can establish communication with, e.g., six RMMs 110, although the VCM 110 may be configured to communicate with more or fewer RMMs 110.

The WVCS 104 is connected to a battery bus of the vehicle 104 for receiving power. Thus, the WVCS 104 receives power in response to the ignition switch of the vehicle 130 being activated.

The WVCS 104 includes a Bluetooth module, a host module, an audio interface module, and an external devices interface module. The Bluetooth module of the WVCS 104 can be the Ericsson ROK101007 or Intel's Bluetooth module. The host module implements the middleware layer of the Bluetooth protocols and the VCM application. The host module can be implemented using a central processing unit (CPU) such as an Intel® Pentium® III or Celeron™, commercially available RAM, ROM, FLASH EPROM, and a USB interface such as Intel's PIIX4, an other interfaces and/or resources. The audio interface module can be the AM79021QJC from AMD or the TP3071 from National Semiconductor. The external devices interface module provides connectivity between the host module and the vehicle device portion 124 using interfaces such as USB, Ethernet, IDE, or RS232, and is implemented with commercially available components.

Included in either the vehicle device portion 124 or the VCM 108 are a terminal display 134, a man-machine interface 136, a multimedia A/V module 138, a wideband wireless communication unit 140, a GPS 142, and a Bluetooth module 144. The terminal display 134 can provide video data through a monitor such as a CRT or an LCD, and audio data through a speaker. The man-machine interface 136 can be, e.g., a keyboard, a stylus and touch-sensitive screen, and/or a microphone, with appropriate controls for interpreting data input using any of these apparatus. Combinations of the display 134 and the interface 136 can provide for various features/services currently available, or that may become available, such as Internet access, email, video telephone calls, and stock quote updates all provided wirelessly to the WVCS 104. The multimedia A/V module 138 controls the receipt and presentation of the audio and video information through the display 134 and the interface 136. The wideband wireless communication unit 140 provides large bandwidth communication of multimedia messages and files. The GPS 142 provides information regarding location of the WVCS 104. The Bluetooth module 144 provides for short-range wireless communication between the WVCS 104 and other devices with Bluetooth functionality within the piconet 112.

Various features/services can be provided by the VCM 108 and/or the RMM 110 and/or the WVCS 104. The VCM 108, RMM 110, and WVCS 104 can provide services provided by the SLDNM 11 (FIG. 1) described above either in conjunction with, or independent of, the SLDNM 11. The VCM 108 can detect RMMs disposed within the piconet 112 that are configured to receive services and RMMs can detect the VCM 108 if the RMM 110 is within the VCM's piconet 112. Communication between the VCM 108 and RMMs 110 can be initiated in response to detection by the VCM 108 of the RAM 110, or vice versa.

Communication between the VCM 108 and the RMMs 110 can establish which services each RMM 110 is configured to receive, the available services depending on the particular RMM 110 and/or a service package associated with the RMM 110 (e.g., that a user of the RMM 110 purchases). Functions/services provided by the SLDNM 11 can be provided by the WVCS 104 in the VCM 108 and/or the RMM 110. The VCM 108 and/or the RMMs 110 can store sets of services for each RMM 110. There may be more than one stored set of services, in which case the desired set can be selected by the RMM user. For example, stored sets may be (1) to handle all incoming communications according to unified messaging and to inhibit all outgoing communications, (2) the same as set (1) but with emergency incoming communications conveyed to the RMM 110 and emergency outgoing communications permitted, (3) the same as set (2) but with a predetermined, or ad hoc, list of sources of incoming communications also conveyed to the RMM 110 or enabled, or (4) conveying all incoming communications to the VCM 108 and permitting all outgoing communications from the RMM 110.

Speed and location of the MS 106 can be determined by communication between the VCM 108 and other devices in the vehicle 130, such as a speedometer of the vehicle 130 and a GPS of the vehicle 130, the MS 106, or the WVCS 104. The determined speed and/or location can be used to provide services to the MS 106 based, e.g., on the location of the MS 106 and a likelihood that the MS 106 is traveling via the vehicle 130.

Messages received by the MS 106 or the VCM 108 can be stored for later retrieval, e.g., when the VCM 108 determines that the vehicle 130 has stopped, possibly for a predetermined amount of time. Recorded messages, announcements, or other audio information can be played, e.g., using the A/V modules 114 and/or 138, and/or the display 134. These devices can provide audio messages as visual messages, e.g., using speech recognition, or visual messages as audio messages, e.g., using text-to-speech apparatus. Messages can be played/provided to the MS user in response to a determination that the vehicle 130 is no longer moving, such as by determining that the vehicle's parking brake has been engaged, or the vehicle's gear selector has been in park, for a predetermined amount of time. Multimedia information and parameters, e.g., regarding limitations on connecting calls while the MS 106 is moving and options for the MS user, can be played/provided to the MS user while the vehicle 130 is moving.

The driving status of the MS user can be determined in response to the vehicle 130 being started or moving by analyzing responses to inquiries during start-up as described below. The driving status of the MS user can be used until it is determined that the vehicle 130 has stopped or the MS user otherwise indicates that the user's driving status has changed.

The VCM 108 and RMM 110 can detect the existence of each other in the piconet 112 and establish relationships for communications. Which device, the VCM 108 or the RMM 110, will initially be the master and which the slave is established. The VCM 108 and the RMM 110 also establish how to manage and organize communication between the WVCS 104 and the BS 14, including whether the VCM 108 will seize the communication channel, intercepting communication to/from the MS 106, while the vehicle 130 is moving.

Unified messaging can be provided by the VCM 108 and/or the RMM 110 and/or the WVCS 104. Unified messaging provides universal access to messages of various types in a common format. Thus, emails and faxes can be converted to audio messages using text-to-speech apparatus, and these converted messages and voicemail messages audibly played to the MS user, e.g., through the MS 106, or a speaker of the WVCS 104 that may be part of the VCM 108 or the vehicle device portion 124. Also, voicemail messages can be converted to text using speech recognition apparatus and these converted messages and email and fax messages displayed, e.g., on a display screen of the MS 106 or the display 134 of the WVCS 104. The VCM 108 can handle incoming messages of various formats that are received while the destination of the message is inhibited from receiving the message, e.g., while the vehicle 130 is moving. The VCM 108 can further provide the messages, in converted or original format as applicable, if the message is not inhibited from being delivered, e.g., at a time when the vehicle 130 is not moving, or has not moved for a predetermined amount of time.

Unified messaging can be provided in various manners. For example, messages can be displayed as single-line summaries on the display 134 or the MS 106. The MS 106 or the WVCS 104 can be configured to allow the user to select a displayed message, and in response to the selection, audibly play or display the full message. If the MS 106 is, e.g., a phone, the MS 106 can audibly play a list of messages.

The VCM 108 and/or the RMM 110 and/or the WVCS 104 can also notify the user of prioritized messages. The messages can be audibly played to the user and can be prioritized based, e.g., on the identity of the caller/sender and/or the content and subject of the message. To determine priority for voice messages, the caller can record a brief message summarizing the subject of the call and the urgency of the call, and the summary played for the user. For data messages, text-to-speech apparatus can be used to convert a portion, e.g., the subject line of an email, to speech and play the speech to the user. Also, the user may preprogram the priority of messages, e.g., based on the sources and/or content of messages or other communications.

The piconet 112 includes the VCM 108 and one or more RMMs 110 and is a peer-to-peer, device-to-device ad hoc network. The piconet 112 may include different RMMs 110 at different times. Devices in the piconet 112 can exchange information to “self configure” by discovering each other and negotiating how each will operate (e.g., which will serve as master and which as slave) and which devices will collaborate, without intervention by a user. The devices in the piconet 112 can use the Bluetooth middleware protocol SDP (Service Discovery Protocol) to set up the piconet 112. SDP provides for devices being the master, providing services, and devices being slaves, looking for services, with devices being able to serve as master or slave at various times. Acting as a server, the VCM 108 controls transactions in the piconet 112. For example, the VCM 108 controls which frequency-hopping sequence the piconet 112 members follow, when frequency hops occur (thus regulating timed events), which frequency is the current frequency, and which slave transmits/receives. The VCM 108 also provides audio, video and multimedia functionality, speed detection/calculation, location functionality, and other functionality available in the WVCS 104. This functionality can be used by the RMM 110 acting as a slave in the piconet 112. The RMM 110 can act as a master and the VCM 108 as slave, with the RMM 110 providing wireless communication for the devices in the piconet 112. The VCM 108 may also act as a slave if the VCM does not communicate wirelessly.

In operation, the system 100 establishes the piconet 112 and provides services to RMMs 110 in the piconet that are configured to receive the services. These services, e.g, may help users of the RMMs 110 to obey laws, be alerted of laws of which the users may not otherwise have been aware, inform callers that the user is unavailable to talk at the moment, inform callers that the user will return their calls, permit incoming communications to be stored and retrieved, receive emergency communications, receive variously-formatted communications in a unified format, and prioritize stored communications.

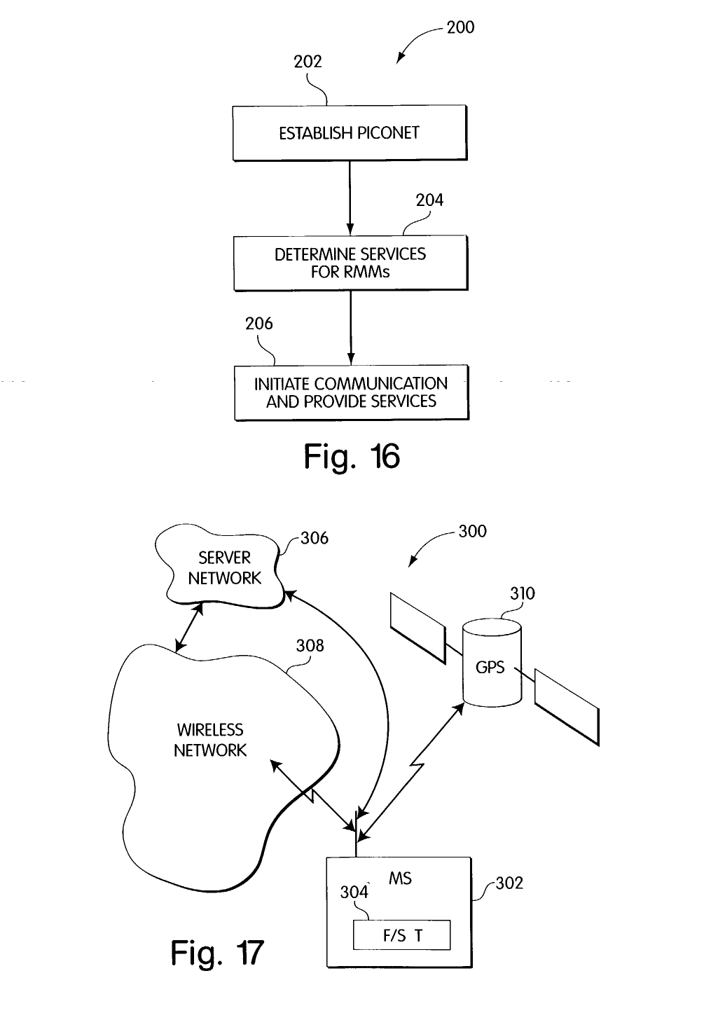

Referring to FIGS. 13 and 16, a process 200 of using the system 100 includes stages 202, 204, and 206. At stage 202, the piconet 112 is established. At stage 204, it is determined what services each of the RMMs 110 are to receive. At stage 206, a communication to/from at least one of the RMMs 110 is initiated and services are provided according to those appropriate for the particular RMM 110 as determined at stage 204.

At stage 202 the piconet 112 is established by the VCM 108 communicating with devices in the vicinity of the VCM 108. The VCM 108 is powered up in response to the vehicle's ignition switch being activated so that the VCM 108 receives power from the vehicle's battery. Having power, the VCM 108 establishes a communication channel with a GPS that is either 32 internal or external to the VCM 108 and the VCM 108 locates itself by communicating with the GPS. The VCM 108 further proceeds to establish the piconet 112 according to The Specification of the Bluetooth System, v1.0B, Dec. 1, 1999. In accordance with the Bluetooth Design Specification, a frequency selection mode ensures that the devices in the piconet 112 transmit and receive information on the same frequency, which may be different for various operation conditions.

At stage 204, the VCM 108 determines which RMMs 110 will receive which services according to inquiry operations. The VCM 108 executes inquiry operations to detect the presence of devices within the piconet 112 that are able to receive services providable by the system 100. Inquiry operations are performed by the VCM 108 periodically, e.g., every 312.5 microseconds. A different listening frequency for the inquiry operations can be selected periodically also, e.g., every 1.28 seconds.

During inquiry operations, devices in the piconet 112 use the 28 least-significant bits of a General Inquiry Access Code (GIAC). The GIAC is, e.g., a 68 or 72 bit field that serves several purposes including identifying the piconet 112. To receive a transmission, a device's receiver is tuned to a particular access code using a correlator. If the correlator matches the access code of an incoming transmission sufficiently, then the receiver will continue receiving the bit stream and pass the stream to higher layers for processing. The system 100 uses three classes of access codes: (1) in normal operation, each transmission is preceded by a Channel Access Code; (2) in page operation, each paging transmission is preceded by a Device Access Code; and (3) during inquiry operations, each inquiry transmission is preceded by an Inquiry Access Code.

If the inquiry operations reveal that there is a device in the piconet that is configured to receive services from the system 100, then the VCM 108 initiates a start-up sequence. This startup sequence issues inquiries to determine which devices will receive which services. For example, the VCM 108 causes audio inquiries to be made through a speaker of the vehicle or displays video inquiries on the display 134. Responses to these inquiries, by one or more of the RMM users, provide parameters for operation of the VCM 108 and provision of services. The VCM 108 identifies the devices found during inquiry operations and inquires what services are to be provided to the devices. For example, the VCM 108 can cause a prompt to be played/displayed in the vehicle 130. The prompt may be, e.g., “Cellular phone number 123 and PDA 12AX have been detected, please indicate which devices are to be active and which services are to be received by each.” The VCM 108 can cause the devices to display menus of options of services that the users of the devices select. The options can be individual services or sets of services defined by the VCM 108 or the user, or can be default sets programmed into the devices. The responses to the VCM's inquiries determine which RMMs 110 receive which services. For example, all RMMs 110 in the piconet 112 may receive services, with the VCM 108 handling messages (e.g., voice calls, emails, messages, pages) to/from all the RMMs 110, or maybe only the driver's RMM 110 may receive services other than connecting all calls, or other variations of devices and services.

The start-up sequence can be superseded by preprogramming of devices that establish services to be received automatically. Devices can have which services are to be provided to them preprogrammed and recognized by the VCM 108. The preprogrammed default services may be various combinations of services. For example, if the device is a phone owned by the owner of the vehicle 130, the user may be assumed to be the driver of the vehicle 130 and the default services are the user's preferences for when the user is a driver. The preprogrammed services may be overridden by the user selecting different services.

Another start-up sequence can be initiated if the VCM 108 detects a device is introduced into the piconet 112, after the initial start-up sequence, for a predetermined amount of time such as five minutes. The operation of this additional start-up sequence is similar to that described above. The introduced device may be an RMM 110 that is or is not configured to receive services from the system 100, or may be another VCM. For example, a new start-up sequence can be initiated in response to another RMM 110 being brought into the vehicle 130 such as if a person enters the vehicle 130, or stands close to the vehicle 130, and has an MS 106 such as a cell phone. Another VCM can be introduced into the piconet 112, e.g., if another vehicle moves close to the vehicle 130 such that the VCM of the other vehicle is within the piconet 112. If another VCM and RMM for receiving services of system 100 are identified in the piconet 112, then the services that the additional RMM should receive are determined.

At stage 206, communication with the piconet 112 is initiated and services are provided. For example, the VCM 108 can control all communication to/from any RMM 110 in the piconet 112 and can take care of all transactions during the life of the piconet 112. The VCM 108 can receive/intercept all communications to a particular RMM 110 in the piconet 112, and can receive/intercept all communications to various RMMs 110 in the piconet 112 that are associated with a common user. Thus, the VCM 108 can handle “one-number find me” services in which a caller can dial one number, and various devices associated with the user (e.g., home phone, work phone, cell phone, pager) are contacted in order to find the user.

The VCM 108 provides the services, among others, provided by the SLDNM 11 as described above. The VCM 108, however, will not inhibit communications in order to establish whether the user of an RMM 110 to receive/transmit a communication is driving if the RMM's user has already established what services are to be provided, and therefore established how to affect communications to/from that RMM. The VCM 108 can inform users of potential illegality (e.g., during the start-up sequence or when a communication is initiated), and the RMM user may choose whether to obey or ignore the law.

Processes 200 and 220 are exemplary, with variations being possible and within the scope of the invention. For example, stages can be added to or deleted from the processes 200 and/or 220, and the stages can be in orders other than those shown.

Also, software for at least the system 100 can be written in JAVA and/or C++ programming languages.

Referring to FIG. 17, the invention has further applicability to the wireless communications and telematics industries. For example, mobile station (MS) 302, of a system 300, includes alerting and filtering/screening technology (F/S T) 304 that allows users to preprogram wireless mobile stations to initiate a series of services based on the location of the mobile station. The pre-programming can be well in advance of, or in response to, an arriving communication. The technology will also be able to recognize the surroundings that a user/mobile station is occupying at any given time (e.g., building, stadium, subway, tunnel, sidewalk, road, field, moving vehicle). The mobile station 302 preferably will work with both network dependent and network independent location technologies, interface with mobile wireless technologies, work across air interfaces, and migrate easily to next generation technologies (3G, Bluetooth™, etc.) to provide the series of services. Services are preferably implemented by devices, e.g., routers under control of a controller, in a Wireless Network 308.

The services available may include a wide range of functionality and provide users with flexibility in handling wireless communications. For example, a user may have an ability to preprogram any number of messaging services so that the mobile station can receive messages of various types. For example, a mobile phone could receive phone calls, emails, website addresses, and/or Internet sites and messages indicating these communications (e.g., phone numbers, or the site/address) could be provided to the user, e.g., on a display of the mobile station. The user may pre-program classes of communications, e.g., such that calls from particular devices/sources are sent to the user's desired destination, e.g., the user's mobile station, office voicemail, and/or home phone. These destinations may vary depending on the situation, e.g., time of day, and can be pre-programmed by the user or be modified by the user at any time. The user may provide special access identifiers for on-demand access, e.g., so that persons calling from unknown/unrecognized devices/sources can enter a password or PIN and be routed according to the user's preference for that person. For example, call may be routed to voicemail if the MS 302 is in a hospital or movie theater, or any location that is designated as prohibiting incoming calls or other communications. Services may include re-routing capabilities for non-programmed services so that if a non-programmed device/source attempts to communicate with the mobile station, and no password/PIN is provided or programmed to be received, then the communication may be re-routed, e.g., to a destination pre-programmed by the mobile station user. The user may pre-designate the type(s) of locations for automatic services activation (e.g., church, restaurant, subway) so that if the mobile station is in a pre-designated location, the services are provided to the mobile station. Services may include designating time periods for service(s) to be active, screening of “spam” messages, unified messaging for like-wired devices, voice alert (e.g., an audible message to the mobile station user in lieu of a ring), voice activation (audible command activation of mobile station functions), and/or automatic “frequent location logging” identification. The mobile station 302 may provide message stacking and automatic call-back capability, notify the user that the service is still active if the user moves from a designated location for service provision, and/or send pre-recorded messages or cause such messages to be sent. The MS 302 may also itself inhibit incoming communications if such communications are prohibited in the MS's location.

How and what service(s) is(are) provided may be flexible. The activation of services can be automatically triggered or manually initiated. The MS 302 may automatically select services in response to recognizing or being told (e.g., by a transmitter in the location, e.g., that broadcasts its location or location type (e.g., hospital, location prohibiting incoming calls) its location. The user may manually select services, e.g., by manually indicating the location or by selecting a description/indication of services. The pre-programming capabilities can be modified on demand. The programming can be done from a variety of devices that can communicate with the mobile station (e.g., a PC, a Wired Phone, WEB TV). The service(s) provided may be provided under various trade names such as MyChoice™, OurChoice™ or YourChoice™. The service(s) can be provided to any wireless device capable of two-way or one-way communications (e.g., a pager).

Additionally, the invention provides techniques for providing services, including screening communications, depending on a situation (according to, e.g., speed, motion, timing) and/or location of a mobile station or system. These techniques can be implemented in a variety of ways. For example, such services can be implemented with a network dependent solution, a network independent solution, a manually-activated solution, a software application, a software daemon application, software applications executing on an operating environment, a software operating environment, hardware within a handset, or a hybrid technique incorporating combinations of any of the mentioned implementations.

In a network-dependent solution, location and/or situation parameters are recognized and transferred to the mobile device 302 by means of a network 306 of servers and devices that interfaces with the Wireless Network 308. The servers/devices can be, e.g., transmitters disposed at various locations, such as hospitals, theaters, restaurants, churches, airplanes, etc. These transmitters transmit indicia of the location and/or what services should be provided (e.g., blocking all calls, blocking all calls except those determined/indicated to be emergencies, rerouting incoming calls or other communications, and blocking outgoing calls or other communications). The device 302 provides indicia to the network 308 to initiate services. The indicia may be the location of the device 302 and/or an instruction for a specific service or services.

In a network-independent solution, location and/or situation parameters are recognized and transferred to the mobile device by means of embedded capabilities inside the wireless device. Such capabilities include, among others, the use of Global Position System (GPS) signals from GPS satellites 310, or other devices capable of recognizing situation—speed, motion, timing—and location independent of exchanging signaling and data with the Wireless Network 308.

In a manually-activated or de-activated solution, activation of the screening and other services can be accomplished by mobile device transmissions, through the networks 308, 310, of special codes such as “*741” for activation (enabling) of services or “*789” for de-activation (disabling) of services on mobile communication wireless devices. For example, this may be accomplished by clicking or otherwise selecting special short-cut icons or running special program routines on computer enabled wireless devices.

In a software application, the location/situation-dependent services and functionality may be implemented as a software application (or set of software applications) executing on top of an operating environment, such as an operating system, within the mobile system. The implementation may be a single monolithic application or several applications with a central Incoming Operator (InO) application that controls the applications to be executed for the incoming communication. The use of an InO allows for additional services and functionality to be easily added to the mobile system.

The application (or InO application) is invoked directly by the operating environment, another software application, or some other application/functionality is implemented in the mobile device upon the initiation of an incoming communication. Control over the incoming communication is transferred to the application (or InO application) which determines how to handle the incoming communication. The control over the incoming communication can include enabling/disabling the mobile device or other functionalities/applications.

In a software daemon application, the location/situation-dependent services and functionality may be implemented as a software daemon executing on top of an operating environment, such as an operating system, within the mobile system. The software daemon continually executes on top of the operating environment. Upon the initiation of an incoming communication, the communication is detected by the daemon and control over that incoming communication is automatically transferred to the daemon. The daemon may invoke other applications to carry out the situation and/or location-dependent services. The daemon may also enable/disable other additional functionalities/applications.

In a software daemon detection solution, the location/situation-dependent services and functionality may be implemented as applications that execute upon an operating environment, such as an operating system. A detection daemon is used to alert the operating environment when the mobile system is in a situation and/or at a location requiring special functionality. The daemon may invoke the applications directly and/or alert the operating environment allowing the operating environment to invoke the appropriate application(s).

In a software operating environment, the location/situation-dependent services and functionality may be implemented as an operating environment, such as an operating system, within the mobile system. The operating environment will directly intercept all incoming communications. Applications may be executed on top of the operating environment to carry out the situation and/or location-dependent services in addition to other functionality. As an operating environment, complete control over the incoming message is obtained, and other functionalities/applications may be enabled/disabled for an incoming message.

In a hardware implementation within a handset, the location/situation-dependent services and functionality may be implemented within the hardware of the mobile system 302. The location/situation-dependent services and functionality may be designed into chipsets contained within the mobile device 302.

In a hybrid implementation, the location/situation-dependent services and functionality may be implemented as a hybrid of any of the above-mentioned implementation types.

What is claimed is:

1. A system for use with a mobile communication unit, the system comprising:
a service device configured to determine at least one service to be applied to affect at least one of incoming and outgoing communications to and from, respectively, the mobile communication unit, the service device being configured to determine the at least one service to be applied dependent upon a location of the mobile communication unit; and
a controller coupled to the service device and configured to implement the at least one service to affect the at least one of incoming and outgoing communications to and from the mobile communication unit, respectively;
wherein the location can be in a set of locations in which the mobile communication unit can send or receive communications to or from, respectively, at least one of a network associated with the mobile communication unit and another communication device associated with the mobile communication unit; and
wherein the service to be applied is independent of a cost for communications using the mobile communication unit at the location.

2. The system of claim 1 wherein the service comprises routing the incoming communication to a destination other than the mobile communication unit.

3. The system of claim 2 wherein the destination other than the mobile communication unit is one of a voicemail system and a further communication device.

4. The system of claim 1 wherein the service comprises at least one of blocking the incoming communication, playing a message, screening the incoming communication, storing the incoming communication, automatically calling back a device originating the incoming communication in response to the mobile communication unit leaving the location, and notifying a user of the mobile communication unit that a service is still active after the mobile communication unit leaves the location.

5. The system of claim 1 wherein the service device is configured to determine the location by using information from the network associated with the mobile communication unit.

6. The system of claim 1 wherein the service device is configured to determine the location by using information independent of information from the network associated with the mobile communication unit.

7. The system of claim 6 wherein the service device is configured to determine the location by using information from a global positioning satellite system.

8. The system of claim 6 wherein the service device is configured to determine the location by using information from a transmitter disposed at the location.

9. The system of claim 1 wherein the location is a region.

10. The system of claim 1 wherein the region is one in which incoming communications to a mobile communication unit are disallowed.

11. The system of claim 1 wherein the service device is further configured to determine the at least one service to be applied dependent upon a situation of the mobile communication unit.

12. The system of claim 11 wherein the situation of the mobile communication unit includes at least one of time of day and speed of the mobile communication unit.

13. A method of providing services relating to at least one of incoming and outgoing communications to and from, respectively, a mobile communication unit, the method comprising:
determining a location of the mobile communication unit, the location being within a set of locations in which the mobile communication can communicate with at least one of a network associated with the mobile communication unit and another communication device associated with the mobile communication unit;
selecting a service depending upon the location of the mobile communication unit, the service affecting at least one of incoming and outgoing communications to and from, respectively, the mobile communication unit; and
affecting at least one of an incoming communication to, and an outgoing communication from, the mobile communication unit in accordance with the selected service;
wherein the service to be applied is independent of a cost for communications using the mobile communication unit at the location.

14. The method of claim 13 the affecting comprises routing the incoming communication to a destination other than the mobile communication unit.

15. The method of claim 14 wherein the destination other than the mobile communication unit is one of a voicemail system and a further communication device.

16. The method of claim 13 wherein the affecting comprises at least one of blocking the incoming communication, playing a message, screening the incoming communication, storing the incoming communication, automatically calling back a device originating the incoming communication in response to the mobile communication unit leaving the location, and notifying a user of the mobile communication unit that a service is still active after the mobile communication unit leaves the location.

17. The method of claim 13 wherein the selecting includes at least one of using information from the network associated with the mobile communication unit, using information independent of information from the network associated with the mobile communication unit, using information from a global positioning satellite system, and using information from a transmitter disposed at the location.

18. The method of claim 13 further comprising determining a situation of the mobile communication unit, and wherein the selecting a service further depends on the situation of the mobile communication unit.

19. The method of claim 18 wherein the situation of the mobile communication unit includes at least one of time of day at the mobile communication unit and speed of the mobile communication unit.

20. A portable communication device configured to at least receive communications, the device comprising:
a receiver configured to receive a location communication indicative of location of the portable communication device;
a transmitter configured to transmit information indicative of the location of the portable communication device in accordance with the location communication; and
a controller configured to inhibit incoming communications, other than the location communication, to the portable communication device in response to the location communication being associated with a location in which incoming communications other than the location communication to the portable communication device are prohibited.

21. The device of claim 20 wherein the controller is further configured to allow incoming communications, in addition to the location communication, to be received and processed by the portable communication device in response to a location communication indicating that the portable communication device is in a location that permits incoming communications other than the location communication.

22. A system for use with a mobile communication unit, the system comprising:
service means for determining at least one service to be applied to affect at least one of incoming and outgoing communications to and from, respectively, the mobile communication unit, the service means for determining the at least one service to be applied dependent upon a location of the mobile communication unit and a situation of the mobile communication unit; and
control means, coupled to the service means, for implementing the at least one service to affect the at least one of incoming and outgoing communications to and from the mobile communication unit, respectively;
wherein the location can be in a set of locations in which the mobile communication unit can send or receive communications to or from, respectively, at least one of a network associated with the mobile communication unit and another communication device associated with the mobile communication unit; and
wherein the service to be applied is independent of a cost for communications using the mobile communication unit at the location.
